(19) United States
(12) Patent Application Publication
(10) Pub. No.: US 2025/0244977 A1
(43) Pub. Date: Jul. 31, 2025

(54) APPARATUSES, COMPUTER-IMPLEMENTED METHODS, AND COMPUTER PROGRAM PRODUCTS FOR TWO-DIMENSIONAL QUANTUM PROGRAM COMPILATION

(71) Applicant: Quantinuum LLC, Broomfield, CO (US)

(72) Inventor: Christopher E. LANGER, Highlands Ranch, CO (US)

(21) Appl. No.: 19/020,315

(22) Filed: Jan. 14, 2025

Related U.S. Application Data
(60) Provisional application No. 63/627,202, filed on Jan. 31, 2024.

(51) Int. Cl. G06F 8/41; G06N 10/80

(52) U.S. Cl. CPC G06F 8/41; G06N 10/80

(57) ABSTRACT

Various embodiments of the disclosure provide apparatuses, systems, and computer program products for instruction compilation for execution in a 2D quantum environment. Some embodiments include identifying a set of starting positions corresponding to a set of qubit pairs for a set of qubits, generating a set of target row assignments based at least in part on the set of starting positions, generating a set of target column assignments comprising a target column assignment for each qubit pair in the set of qubit pairs, the set of target column assignments generated by applying a one-dimensional sorting algorithm to each row of the set of target row assignments, and generating at least one movement instruction based at least in part on the first set of swap-or-not operations and the second set of swap-or-not operations.

### CROSS-REFERENCE TO RELATED APPLICATION(S)

This application claims priority to U.S. Application No. 63/627,202, filed Jan. 31, 2024, the content of which is incorporated herein by reference in its entirety.

### TECHNICAL FIELD

Embodiments of the present disclosure generally relate to compiling programs for efficient quantum computer execution, and specifically to efficient compilation of quantum programs in a two-dimensional (2D) quantum computing environment.

### BACKGROUND

Execution of a quantum program may involve gate operations of one or more qubit pairs. Certain quantum computer implementations perform gate operations on adjacent qubit pairs. The qubits of a qubit pair must be appropriately positioned to enable such gate operations. In a 2D environment, qubits are stored in different locations of a 2D arrangement.

Applicant has discovered problems with current implementations of efficiently compiling a quantum program in a 2D quantum computing environment. Through applied effort, ingenuity, and innovation, Applicant has solved many of these identified problems by developing embodied in the present disclosure, which are described in detail below.

### BRIEF SUMMARY

In general, embodiments of the present disclosure are provided for efficient compilation of a quantum program for execution in a 2D quantum computing environment. Other implementations for efficient compilation of a quantum program for execution in a 2D quantum computing environment will be, or will become, apparent to one with skill in the art upon examination of the following figures and detailed description. It is intended that all such additional implementations be included within this description be within the scope of the disclosure and be protected by the following claims.

In one aspect, a computer-implemented method includes identifying a set of starting positions corresponding to a set of qubit pairs for a set of qubits, the set of starting positions representing a two-dimensional environment includes a number of rows and a number of columns, generating a set of target row assignments based at least in part on the set of starting positions, the set of target row assignments includes a target row assignment for each qubit pair in the set of qubit pairs, where the set of target row assignments is generated corresponding to a first set of swap-or-not operations, generating a set of target column assignments includes a pair of adjacent target column assignments for each qubit pair in the set of qubit pairs, the set of target column assignments generated by applying a one-dimensional sorting algorithm to each row of the set of target row assignments, where the set of target column assignments is generated corresponding to a second set of swap-or-not operations, and generating at least one movement instruction based at least in part on the first set of swap-or-not operations and the second set of swap-or-not operations.

The computer-implemented method may also include further includes determining the set of starting positions satisfies an even-odd constraint for each qubit pair.

The computer-implemented method may also include where the set of starting positions includes a set of updated starting positions, the computer-implemented method further includes determining, from an initial starting positions set, at least one qubit pair of the set of qubit pairs does not satisfy an even-odd constraint, and swapping at least one qubit of each qubit pair of at least a subset of the at least one qubit pair to generate the updated set of starting positions, where the updated set of starting positions satisfies the even-odd constraint for each qubit pair of the set of qubit pairs, and where each swap to generate the updated set of starting positions is performed in a single time step.

The computer-implemented method may also include where generating the set of target row assignments includes generating a graph includes a first node set and a second node set, where the first node set includes at least one node corresponding to each even column index for the number of columns and where the second node set includes at least one node corresponding to each odd column index for the number of columns, where the graph further includes an edge for each particular qubit pair from a first node of the first node set to a second node of the second node set, the first node corresponding to a first column of a first starting position of a first qubit of the particular qubit pair and the second node corresponding to a second column a second starting position of a second qubit of the particular qubit pair. The computer-implemented method may also include assigning starting positions to each target row to generate a target row assignment corresponding to the target row by at least applying at least one iteration of a perfect matching algorithm for each row, and for each particular iteration, generating a target row assignment for a particular row by assigning the starting positions for the particular row corresponding to a maximum histogram of minimum weights determined based at least in part on the particular iteration, where the at least one iteration continues until each qubit is represented in a target row assignment.

In an example embodiment, the perfect matching algorithm comprises a minimum weight perfect matching algorithm that performs based on edge weights determined at least in part on the starting rows of the qubit pairs associated with the edges and a candidate target row.

In an example embodiment, the first target row is selected from a set of available target rows based at least in part on the sum of weights of the minimum weight perfect matching associated with the target row in relation to the sum of weights of minimum weight perfect matchings associated with one or more available target rows.

The computer-implemented method may also include further includes transmitting the at least one movement instruction to an external controller that, in response to receiving the at least one movement instruction, controls a quantum computer based at least in part on the at least one movement instruction.

The computer-implemented method may also include further includes activating a quantum computer to perform the first set of swap-or-not operations and the second set of swap-or-not operations represented by the at least one movement instruction.

The computer-implemented method may also include further includes identifying at least one swappable path or ensure that no swappable paths exist, where each swappable path of the at least one swappable path if it exists connects a first non-compliant terminal with a second terminal, where swapping the at least one qubit of each qubit pair of at least the subset of the at least one qubit pair represents each swap along the at least one swappable path.

The computer-implemented method may also include where each swappable path includes the first non-compliant terminal and a second terminal connected by zero or more even-odd or odd-even intermediate qubit pairs. The first non-compliant terminal may be embodied by an even-even qubit pair and the second terminal embodying an odd-odd qubit pair; the first non-compliant terminal may be embodied by an even-even qubit pair and the second terminal embodied by an odd-only qubit; or the first non-compliant terminal may be embodied by an odd-odd qubit pair and the second terminal embodied by an even-only qubit.

The computer-implemented method may also include where identifying the at least one swappable path includes identifying a plurality of candidate swappable paths, each candidate swappable path connecting a first candidate non-compliant terminal with a second candidate terminal, generating a graph, where the graph includes a first node set includes a node for each first candidate non-compliant terminal and where the graph includes a second node set includes a node for each second candidate terminal, and where the graph includes an edge connecting each first node of the first node set with a second node in the second node set, where the first node is associated with at least a first qubit adjacent to a second qubit of the second node, and identifying the at least one swappable path by applying an efficient disjoint path algorithm to the graph.

The computer-implemented method may also include further includes assigning a weight to each edge, where the weight for each particular edge is determined based at least in part on a swap savings determined based at least in part on the initial starting positions and a second set of starting positions after swapping the candidate swappable path corresponding to the particular edge.

The computer-implemented method may also include further includes identifying an additional candidate swappable path representing a closed cycle path and including the additional candidate swappable path in the at least one swappable path.

The computer-implemented method may also include further includes identifying an additional candidate swappable path includes a first terminal representing a terminal even index and a second terminal representing a second terminal representing a terminal odd index, generating an alternative starting positions set representing swapping along the additional candidate swappable path, determining the alternative starting positions set is associated with a swap savings compared to the initial starting positions set, and including the additional candidate swappable path in the at least one swappable path.

The computer-implemented method may also include where assigning the starting positions includes processing the graph utilizing a modified Suurballe's algorithm at each iteration.

In accordance with another aspect of the disclosure an apparatus is provided comprising at least one processor and at least one memory having computer-coded instructions stored thereon that, in execution with the at least one processor, causes the apparatus to perform any one of the example computer-implemented methods described herein.

In accordance with another aspect of the disclosure a computer program product is provided including at least one non-transitory computer-readable storage medium having computer program code stored thereon that in execution with at least one processor configures the computer program product in conjunction with the at least one processor to perform any one of the example computer-implemented methods described herein.

Other technical features may be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a block diagram of a system that may be specially configured within which embodiments of the present disclosure may operate.

FIG. 2 illustrates a block diagram of an example apparatus that may be specially configured in accordance with at least one example embodiment of the present disclosure.

FIG. 3 illustrates an example data architecture for compiling at least one quantum program in a 2D quantum computing environment in accordance with at least one example embodiment of the present disclosure.

FIG. 4 illustrates a visualization of qubits in an example 2D quantum computing environment in accordance with at least one example embodiment of the present disclosure.

FIG. 5 illustrates a visualization of qubits sorted to adjacency for gating in a 2D quantum computing environment in accordance with at least one example embodiment of the present disclosure.

FIG. 6 illustrates a visualization of an iteration of a perfect matching algorithm performed during target position assignment of qubits in accordance with at least one example embodiment of the present disclosure.

FIG. 7 illustrates a representation of swap-or-not operations in a 2D quantum computing environment in accordance with at least one example embodiment of the present disclosure.

FIG. 8 illustrates a flowchart including example operations of a process for generating a set of target positions for a set of qubits in accordance with at least one example embodiment of the present disclosure.

FIG. 9 illustrates a flowchart including example operations of a process for updating an initial starting positions set in accordance with at least one example embodiment of the present disclosure.

FIG. 10 illustrates a flowchart including example operations of a process for generating target row assignments in accordance with at least one example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Quantum programs are often coded in a manner logically defined based on qubit pairing. Such quantum programs define a sequence of qubit pairs for gating, where the gating of qubit pairs in a quantum computer enables execution of logic gates based on the qubit pairs. To enable gating of multiple different qubit pairings that utilize the same qubits, the quantum program may be defined across multiple time steps, where each time step defines different sets of qubit pairs that are executable concurrently.

Execution of operations that manipulate qubits in a quantum computer remains computationally expensive in terms of execution time, power consumption, and the like. Comparatively, processing of a quantum program utilizing classical computing to generate instructions executed by quantum computer components that affect the qubits remains relatively inexpensive. Accordingly, the inventors identified that compiling a quantum program into instructions for execution by a quantum computer that enables the quantum computer to perform gating operations of a quantum program efficiently is advantageous for minimizing computing resource expenditure and execution time.

In some contexts, a quantum computer defines a two-dimensional (2D) environment in which qubits are positioned and stored for use in gating. For example, in various contexts a quantum computer stores qubits positioned along a grid arrangement of positions defining R rows and C columns, with each qubit at a position defined by a (r, c) pair where r is a row value and c is a column value. In some such implementations, qubits may be utilized to execute a logical gate only in circumstances where the qubits are located at positions adjacent to one another in the 2D environment. Thus, processing of the quantum program benefits significantly from compiling the quantum program into particular instructions that, upon execution by a quantum computer, reposition particular qubits to adjacent positions for gating at each time slice of the quantum program, such that the logical operations are performable on each qubit pair at that time slice. Such benefits net overall computing resource savings and efficiencies by expending additional classical computing resources to reduce operations that are required by the quantum computer to efficiently route qubits to particular positions that enable such gating, particularly because each operation of the quantum computer for qubit manipulation utilizes more computing resources than algorithmic processing of data sets utilizing classical computing. In this regard, the inventors have identified that compiling a quantum program using classical computing into particular instructions that are efficiently executable by a quantum computer (e.g., by reducing a number of swap or other qubit manipulation operations required to reposition the qubits for performance of at least one gate operation) in a 2D environment reduces the overall expenditure of computing resources and execution time required to execute the quantum program.

Embodiments of the present disclosure provide for compilation of a quantum program into efficiently-executable instructions, specifically for execution in a 2D quantum computing environment. In this regard, embodiments of the present disclosure expend classical computing resources (e.g., processing resources, memory resources, networking resources, and the like) to determine manipulations and/or other actions that are to be performed in a quantum computer to efficiently route qubits of the quantum computer for gating. The classical computing algorithms for compilation of a quantum computer into a series of actions to be performed are performed significantly faster and with less error than manipulations of qubits in a quantum environment. In this regard, classical computing algorithms may be utilized to determine what qubit manipulations should be performed in the 2D quantum computing environment to position a set of qubits for gating as defined by a quantum program, thus enabling a reduction in overall time-to-execution of the quantum program by reducing the number longer to perform steps (e.g., of qubit manipulations and/or related actions) to be performed via resource-intensive quantum components of the quantum computer (e.g., an ion trap, lasers, cooling equipment, and/or the like that maintains, uses, stores, and/or otherwise interacts with one or more qubits). Additionally, by compiling the quantum program to determine a reduced number of qubit manipulations, such determinations reduce risk of error resulting during the execution of the quantum program (e.g., during actual performance of the qubit manipulations). In this regard, as classical computing operations (e.g., processing of data via a specially-configured processor and/or memory) are performable with greater speed and with reduced risk as compared to quantum computing operations (e.g., manipulation, storage, use, and/or other interaction with one or more qubits), embodiments of the present disclosure utilize such quicker classical computing algorithms to determine movement instructions for accurately performing a quantum program with improved efficiency as compared to naïve or other generalized implementations of the quantum program, thus reducing the overall time-to-completion of the quantum program and reduction of error likelihood associated with execution of the quantum program.

### Definitions

“2D quantum computing environment” refers to components that store qubits in a two-dimensional arrangement having R rows and C columns.

“Candidate swappable path” refers to an identified set of adjacent positions that connects a non-compliant terminal qubit pair with another non-compliant terminal qubit pair or compliant terminal qubit, where swapping the qubits along the set of adjacent positions eliminates one or more non-compliant qubit pairs and replaces non-compliant qubit pairs and qubit pairs within the swappable path with qubit pairs satisfying the even-odd constraint.

“Closed cycle path” refers to a swappable path in a graph from a first qubit index to the first qubit index that does not repeat any intermediary edges or nodes in the graph.

“Efficient disjoint path algorithm” refers to a graph processing algorithm that finds disjoint paths from source to target in a graph in a manner that satisfies an optimization objective. Non-limiting examples of an efficient disjoint path algorithm include Suurballe's algorithm.

“Even-odd constraint” refers to an electronically-performed determination of whether qubits of a qubit pair are associated with one even column index and one odd column index. In some contexts, each qubit pair in a set of starting positions must satisfy the even-odd constraint before the set of starting positions is processable for optimization via one or more swap-or-not operations.

“Initial starting positions set” refers to a set of starting positions corresponding to a set of qubits, where the set of starting positions includes at least one qubit pair that does not satisfy the even-odd constraint, and where the initial starting positions set is processed for to generate an updated starting positions set that satisfies the even-odd constraint.

“Intermediary qubit pair” refers to a qubit pair associated with at least one qubit assigned a position index between a first terminal qubit group and a second terminal qubit group in a candidate swappable path.

“Movement instruction” refers to computer program code instructions that facilitate operation of at least one component of a quantum computer that facilitates manipulation, storage, transport, transfer, and/or other use of one or more qubits via the at least one component.

“Non-compliant terminal” refers to a qubit pair that does not satisfy the even-odd constraint, where the qubit pair embodies a terminal qubit group of a candidate swappable path.

“Quantum computer” refers to electronic components embodied in hardware, software, firmware, and/or any combination thereof, that operate to store, manipulate, and/or otherwise use at least one qubit to perform at least one logical gate based on the at least one qubit. A quantum computer includes (i) at least one quantum computing component that interacts with the at least one qubit, and (ii) at least one classical computing component that performs classical software processing to determine how to control the at least one quantum computing component of the quantum computer.

“Quantum program” refers to electronically managed data that defines a set of logical gates to perform on a set of qubit pairs across at least one time step, where each time step includes one or more logical gates that are performable in parallel with one another.

“Qubit manipulation” refers to any operation performed by at least one quantum computing component that repositions a qubit in a 2D quantum computing environment and/or performs a logic gate based on at least one qubit in the 2D quantum computing environment.

“Qubit pair” refers to electronically managed data representing two qubits that are marked for a particular gate by a quantum program. In some contexts, a qubit pair includes a first qubit corresponding to a first position index and second qubit corresponding to a second position index, where the first position index represents a current position of a first qubit in a 2D quantum computing environment and the second position index represents a current position of a second qubit in the 2D quantum program, where a logical gate is to be performed at a particular time step utilizing the first qubit and second qubit. In some contexts, a qubit pair includes a single actual position index corresponding to a first qubit, and optionally includes an open or otherwise reserved value that indicates no other specific qubit is required to be paired with the first qubit. Qubits of a qubit pair must reach adjacent positions in a 2D quantum computing environment for execution of a logic gate based on such qubits.

“Set” refers to at least one electronically maintained data structure that stores zero or more data objects of a particular object type. A set may arrange data objects in an ordered or unordered manner. The term “set” may be utilized to modify a particular data object type to indicate that the set includes zero or more of that data type. For example, a “node set” or “set of nodes” refers to a set including any number of representations of node data objects, and a “qubit set” refers to a set including any number of representations of qubits.

“Starting position” refers to a particular electronically managed data value that indicates a position index of a current position corresponding to a qubit at a beginning of a particular time step. A qubit is repositioned from a starting position to a target position during the time step.

“Swap savings” refers to electronically managed data that indicates a reduction in time steps required to arrange a set of qubits from a starting positions set based at least in part on a set of qubit pairs for a particular time step, where the reduction is achieved by performing a single time step of one or more swap-or-not operations in parallel.

“Swap-or-not operation” refers to electronically managed data indicating whether to perform a swap of adjacent qubits at two particular position indices.

“Swappable path” refers to an arrangement of adjacent qubits positions identified as connecting a first terminal qubit group and a second terminal qubit group that are swappable in parallel to alter one or more qubit pairs to starting positions that satisfy an even-odd constraint and/or to reposition qubits to take advantage of a determined swap savings.

“Target column assignment” refers to electronically managed data that represents a column index in a 2D quantum computing environment for a target position to be reached, during a particular time step, by a qubit corresponding to a particular starting position.

“Target position” refers to electronically managed data representing a particular position or index corresponding to a particular position in a 2D quantum computing environment, where a particular qubit is to reach the particular position in the 2D quantum computing environment during a particular time step. A target position is representable in some contexts as a tuple including a row index and a column index. A particular target position in some contexts is representable as a single linear value, for example where the single linear value represents a combination of (row index of particular position * total number of columns in row)+column index of particular position. A particular target position in some contexts is representable as a single linear value, for example where the single linear value represents a combination of (column index of particular position*total number of rows in column)+row index of particular position.

“Target row assignment” refers to electronically managed data that represents a row index in a 2D quantum computing environment for a target position to be reached, during a particular time step, by a qubit corresponding to a particular starting position.

“Terminal qubit group” refers to electronically managed data defining a position index or position indices corresponding to a qubit or two qubits that represents a beginning or an end of a candidate swappable path. The terminal qubit group in some contexts includes a single qubit, such as a single odd index qubit or a single even index qubit. A terminal qubit group in some contexts includes two qubits associated with position indices, for example at even-even position indices or odd-odd position indices that fails to satisfy the even-odd constraint.

“Time step” refers to a defined period of time during which a portion of a quantum program is performable, the portion of the quantum program defining a set of operations to be performed on one or more qubits, where the set of operations are performable in parallel with one another over the defined period of time.

### Example Systems and Apparatuses of the Disclosure

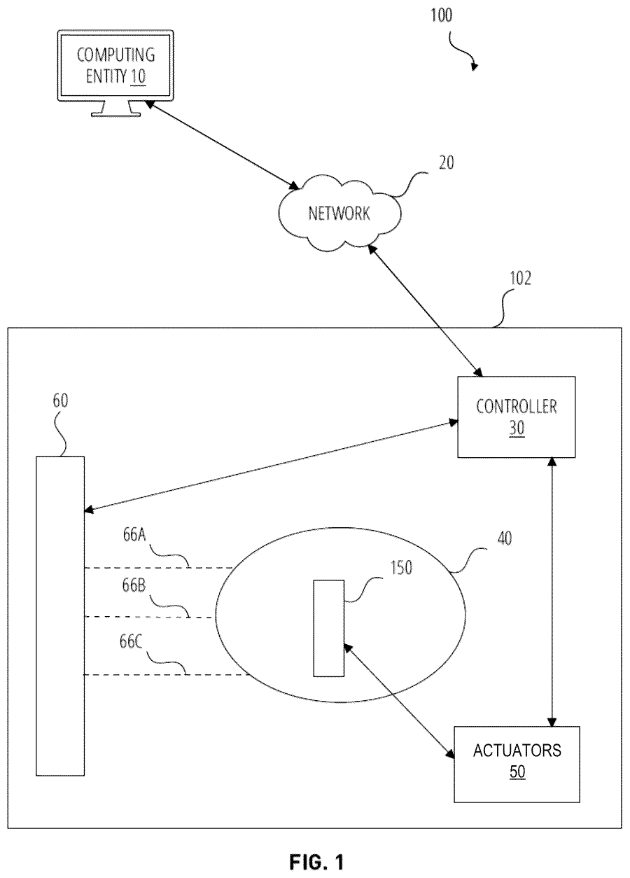

FIG. 1 illustrates a block diagram of a system that may be specially configured within which embodiments of the present disclosure may operate. The block diagram provides a schematic diagram of an example quantum computer system 100 (“system 100”) comprising an 2D qubit containment apparatus 150, in accordance with an example embodiment. In various embodiments, the system 100 comprises a computing entity 10 and a quantum computer 102. In various embodiments, the quantum computer 102 comprises a controller 30, a cryostat and/or vacuum chamber 40 enclosing an 2D qubit containment apparatus 150, one or more manipulation sources 60, and one or more actuators 50. In an example embodiment, the one or more manipulation sources 60 may comprise one or more lasers (e.g., optical lasers, microwave sources, and/or the like). In various embodiments, the one or more manipulation sources 60 are configured to manipulate and/or cause a controlled quantum state evolution of one or more qubits in the 2D qubit containment apparatus 150. For example, in an example embodiment, the one or more manipulation sources 60 comprises one or more lasers, the lasers may provide one or more laser beams to an ion trap within the chamber 40 via corresponding beam paths 66 (e.g., 66A, 66B, 66C). In various embodiments, the quantum computer 102 comprises one or more actuators 50. The actuators 50 may include any number of general actuators that control the movement of qubits within the 2D quantum environment of the quantum computer 102. It will be appreciated that different actuators may be implemented for different implementations of quantum computers. For example, for ions, the actuators 50 may comprise a plurality of transport and/or trapping (TT) voltage drivers and/or voltage sources and/or at least one radio frequency (RF) driver and/or voltage source. The actuators 50 may be electrically coupled to the corresponding TT electrodes and/or RF rails for generation of the trapping potential configured to trap one or more ions within the ion trap of the 2D qubit containment apparatus 150 via the corresponding electrical leads. Additionally or alternatively, for neutral atoms, the actuators 50 in some embodiments includes any number of controllers associated with one or more arrays of laser beams. Additionally or alternatively, for superconducting qubits the actuators 50 include control software to determine which swap gates are to be applied. Additionally or alternatively, for logical qubit architectures employing the actuators 50 comprising surface code that run software to determine which surface code patches move past each other and/or what logical swap operations are applied. Additionally or alternatively, for solid state and/or quantum dot qubits the actuators 50 include control software to determine which swap gates are to be applied.

In various embodiments, the system 100 may include various other components and/or assemblies, such as a measurement system configured for use in determining a quantum state of one or more qubits confined by the 2D qubit containment apparatus 150. For example, in an example embodiment where the qubits are trapped ions, the measurement system may include one or more photodetectors configured to capture and/or detect photons fluoresced by the qubits. In another example, the system 100 includes a magnetic field system configured to control the magnetic field at one or more locations of the 2D qubit containment apparatus 150.

The 2D qubit containment apparatus 150 includes any entity in which quantum information must move in a two-dimensional environment to become adjacent to effectuate a gate. It will be appreciated that the 2D qubit containment apparatus 150 is embodiable in a myriad of configurations that store and position qubits within such a two-dimensional environment. Non-limiting examples of a 2D qubit containment apparatus 150 include an ion trap apparatus, a superconducting apparatus, a quantum dot apparatus, and a neutral atom apparatus. The 2D qubit containment apparatus 150 in some embodiments includes fixed qubits and/or moveable qubits.

In some such embodiments, the 2D qubit containment apparatus 150 includes and/or otherwise defines one or more physical regions at which a qubit may be located, or otherwise positioned, within the ion trap. In various embodiments, the regions are arranged in a particular array and/or two-dimensional arrangement with such defined positions, for example across a rotated axis ion trap (e.g., defined by the RF rails of the ion trap). One example embodiment includes a rotated grid ion trap or other multi-dimensional atomic object confinement apparatus as depicted and described in U.S. application Ser. No. 18/461,889 titled “MULTI-DIMENSIONAL ATOMIC OBJECT CONFINEMENT APPARATUS” and filed Sep. 6, 2023, the contents of which are incorporated by reference herein in their entireties. The physical regions may be defined to maintain position of the qubits and/or enable use of particular qubits, for example for execution of one or more logic gates (“gating”) on a particular qubit or adjacent qubits. In at least one example context, each physical region is configured to enable storage of one or more qubits at that region while maintaining a well-defined order of the qubit positions across all regions in the ion trap. In this regard, each physical region of the ion trap may be represented by position index that defines the position in the order of said physical regions, for example based on a single index value or a combination of row index and column index.

Alternatively or additionally, in some embodiments, the ion trap is configured to enable movement of regions and movement of the qubits within those regions along the ion trap. In some such embodiments, adjacent qubits within the qubit ordering may have their positions swapped to enable repositioning of qubits in the 2D quantum computing environment. In this regard, a qubit located at a first position may be swapped with a second position that is adjacent in the direction of row or column. For example, a qubit at position Z representing (r, c), where r is a row value and c is a column value, Z is swappable with the positions at (r, c−1), (r, c+1), (r−1, c), and (r+1, c). Such positions may correspond to Z−1, Z+1, Z−C, and Z+C respectively in a row-major linear indexing schema, where C is the total number of columns per row in the 2D quantum computing environment. In some embodiments, for example, voltage signals may be applied to the electrodes (e.g., TT electrodes) of the ion trap to cause a potential experienced by the ions within the ion trap that causes one or more actions for swapping adjacent qubits to allow for such repositioning (e.g., in a swap between position A and position B in the qubit ordering, a qubit initially at position A becomes positioned at position B, and the qubit at position B becomes positioned at position A in parallel and/or otherwise substantially at the same time). In some embodiments, the qubits are repositioned along distinct junctions to enable such repositions to occur substantially in parallel within the 2D quantum computing environment.

It will be appreciated that a 2D quantum computing environment may be embodied in any of a myriad of arrangements. For example, in some embodiments, the 2D quantum computing environment includes fixed position superconducting qubits laid out in two dimensions. In some embodiments, the 2D quantum computing environment includes fixed position solid state qubits laid out in two dimensions. In some embodiments, the 2D quantum computing environment includes fixed position neutral atoms laid out in two dimensions. In some embodiments, the 2D quantum computing environment includes moveable neutral atoms laid out in two dimensions. In some embodiments, the 2D quantum computing environment includes logical qubits laid out in two dimensions, including logical qubits formed from the surface code, the color code, or other stabilizer or non-stabilizer code.

It will be further appreciated that the instructions generated by the present invention to swap qubits in moveable qubit quantum computing architectures (e.g., movable trapped ion quantum computers or movable neutral atom quantum computers) are directly applicable to swapping the quantum information stored in qubits using quantum swap gates while leaving the qubits in their original positions. Furthermore, such swap gates may be applied to adjacent logical qubits formed from a plurality of physical qubits. Therefore, the methods of the present invention are applicable to moveable qubit architectures and fixed qubit architectures and logical qubit architectures.

In various embodiments, a computing entity 10 is configured to allow a user to provide input to the quantum computer 102 (e.g., via a user interface of the computing entity 10) and receive, view, and/or the like output from the quantum computer 102. The computing entity 10 may be in communication with the controller 30 of the quantum computer 102 via network 20, for example that includes one or more wired or wireless networks and/or via a direct wired and/or wireless communications network. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control the actuators 50, cryogenic system and/or vacuum system controlling the temperature and pressure within the chamber 40, manipulation sources 60, and/or other systems controlling various environmental conditions (e.g., temperature, pressure, and/or the like) within the chamber 40 and/or configured to manipulate and/or reposition and/or cause a controlled evolution of quantum states of one or more qubits (e.g., ions, neutral atoms, superconducting qubits, solid state qubits, and/or the like). In various embodiments, some or all of the ions trapped within an ion trap are used as qubits of the quantum computer 102.

In some embodiments, the controller 30 is embodied by one or more classical computing components configured for performing compilation of a quantum program, processing of a starting positions set, even-odd transposition sorts, graph generation and/or graph processing, target row and/or target column assignment of qubits, generation of movement instructions, and/or the like. The controller 30 may include classical computing components, such as at least one processor, at least one memory, and/or the like, that are configured to receive and/or otherwise generate a quantum program and compile the quantum program into instructions efficiently executable by a quantum computer maintaining a 2D quantum computing environment, such as the quantum computer 102. In this regard, the controller 30 may be configured to generate appropriate instructions for controlling the quantum computer 102 in the manner desired (e.g., to reposition various qubits to desired positions based on the swap-or-not operations determined via target position assignments for the various qubits).

Alternatively or additionally, in some embodiments, the computing entity 10 is configured for performing the compilation of a quantum program to determine corresponding swap-or-not operations that position the qubits for gating according to the quantum program. In some such embodiments, the computing entity 10 is configured to communicate some or all of the generated data (such as a swap command set representing the swap-or-not operations determined during compilation of the quantum program). In this regard, the data generated via the computing entity 10 may be utilized by the controller 30 for controlling the quantum computer 102 in the manner desired (e.g., to generate corresponding movement instructions and/or actuate the other quantum components of the quantum computer 102 to reposition various qubits to desired positions and/or reposition the quantum information stored in fixed position qubits to desired qubit locations), such that the computing entity 10 indirectly controls at least one aspect of the quantum computer 102.

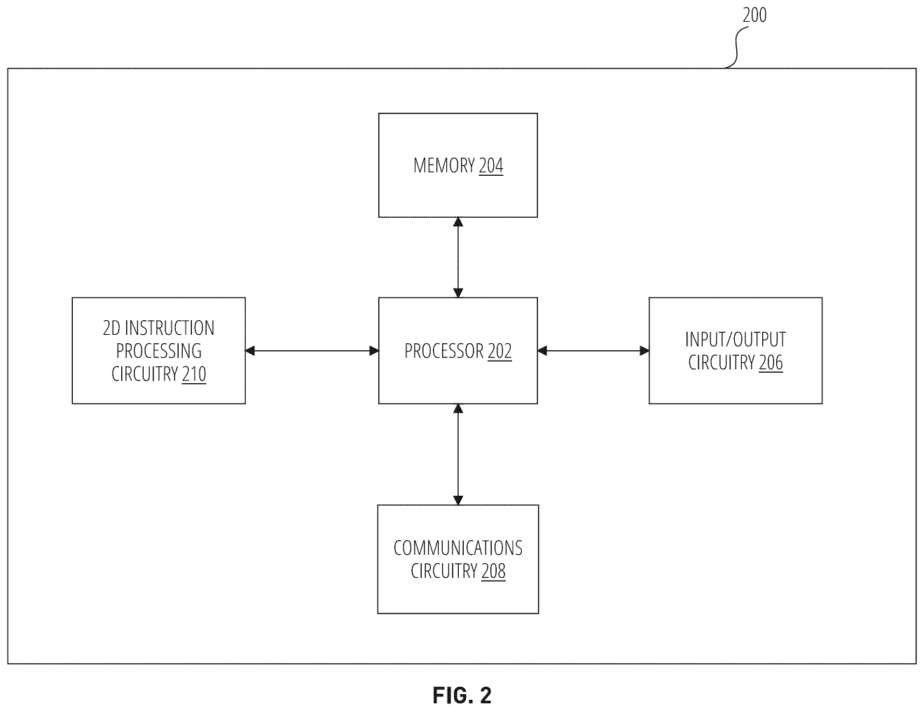

FIG. 2 illustrates a block diagram of an example apparatus that may be specially configured in accordance with at least one example embodiment of the present disclosure. The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a variety of mobile terminals, mobile telephones, smartphones, laptop computers, tablet computers, or any combination of the aforementioned devices.

In at least one example embodiment, the controller 30 is embodied by one or more computing systems, such as the apparatus 200 as shown in FIG. 2. In other embodiments, the computing entity 10 is embodied by the apparatus 200 as shown in FIG. 2. The apparatus 200 may include a processor 202, memory 204, input/output circuitry 206, communications circuitry 208, and/or 2D instruction processing circuitry 210. In some embodiments, the 2D instruction processing circuitry 210 is optional, may be embodied by one or more of the other circuitry, and/or may be embodied by another system associated with the apparatus 200.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the apparatus 200 provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the apparatus 200. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 202 is configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions specifically configure the processor 202 to perform the algorithms embodied in the specific operations described herein when such instructions are executed.

As one particular example embodiment, the processor 202 is configured to perform various operations associated with compilation of a quantum program, for example to determine swap-or-not operations utilized to efficiently position qubits in a quantum computer. In some such embodiments, the processor 202 includes hardware, software, firmware, and/or a combination thereof that generates and/or receives a quantum program. Additionally or alternatively, in some embodiments, the processor 202 includes hardware software, firmware, and/or a combination thereof that generates a set of target row assignments based at least in part on qubit pairs of a particular starting positions set defined by the quantum program. Additionally or alternatively, in some embodiments, the processor 202 includes hardware software, firmware, and/or a combination thereof that generates a set of target column assignments based at least in part on the qubit pairs and the set of target row assignments. Additionally or alternatively, in some embodiments, the processor 202 includes hardware software, firmware, and/or a combination thereof that generates movement instructions based at least in part on generated target row assignments and/or target column assignments.

In some embodiments, the apparatus 200 includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 208 includes, for example, a network interface for enabling communications with a wired or wireless communications network. Additionally or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from user device, one or more asset(s) or accompanying sensor(s), and/or other external computing device in communication with the apparatus 200.

In some embodiments, the apparatus 200 includes 2D instruction processing circuitry 210. The 2D instruction processing circuitry 210 includes hardware, software, firmware, and/or any combination thereof, that supports compilation of a quantum program, or data thereof, to determine swap-or-not operations for efficiently positioning qubits and/or quantum information stored in qubits in accordance with the quantum program. For example, in some such embodiments, the 2D instruction processing circuitry 210 includes hardware, software, firmware, and/or any combination thereof, that receives a quantum program. Additionally or alternatively, in some such embodiments, the 2D instruction processing circuitry 210 includes hardware, software, firmware, and/or any combination thereof, that identifies a set of starting positions corresponding to a set of qubit pairs. Additionally or alternatively, in some such embodiments, the 2D instruction processing circuitry 210 includes hardware, software, firmware, and/or any combination thereof, that generates a set of target row assignments based at least in part on the set of starting positions. Additionally or alternatively, in some such embodiments, the 2D instruction processing circuitry 210 includes hardware, software, firmware, and/or any combination thereof, that generates a set of target column assignments corresponding to the set of qubit pairs, the set of target column assignment based at least in part on the set of target row assignments. Additionally or alternatively, in some such embodiments, the 2D instruction processing circuitry 210 includes hardware, software, firmware, and/or any combination thereof, that updates an initial starting positions set into a starting positions set for further processing. Additionally or alternatively, in some such embodiments, the 2D instruction processing circuitry 210 includes hardware, software, firmware, and/or any combination thereof, that generates a graph based at least in part on the set of qubit pairs for a particular time step. Additionally or alternatively, in some such embodiments, the 2D instruction processing circuitry 210 includes hardware, software, firmware, and/or any combination thereof, that processes a graph to identify one or more swappable paths. Additionally or alternatively, in some such embodiments, the 2D instruction processing circuitry 210 includes hardware, software, firmware, and/or any combination thereof, that generates at least one movement instruction based on swap-or-not operations determined during generation of the set of target row assignments and/or the set of target column assignments. In some embodiments, the 2D instruction processing circuitry 210 includes a separate processor, specially configured field programmable gate array (FPGA), or a specially programmed application specific integrated circuit (ASIC).

Additionally or alternatively, in some embodiments, two or more of the sets of circuitries embodying processor 202, memory 204, input/output circuitry 206, communications circuitry 208, and 2D instruction processing circuitry 210. Alternatively or additionally, in some embodiments, one or more of the sets of circuitry processor 202, memory 204, input/output circuitry 206, communications circuitry 208, and/or 2D instruction processing circuitry 210 perform some or all of the functionality described associated with another component. For example, in some embodiments, two or more of the sets of circuitry embodied by processor 202, memory 204, input/output circuitry 206, communications circuitry 208, and/or 2D instruction processing circuitry 210, are combined into a single module embodied in hardware, software, firmware, and/or a combination thereof. Similarly, in some embodiments, one or more of the sets of circuitry, for example 2D instruction processing circuitry 210, is combined with the processor 202, such that the processor 202 performs one or more of the operations described above with respect to 2D instruction processing circuitry 210.

### Example Computing Environments of the Disclosure

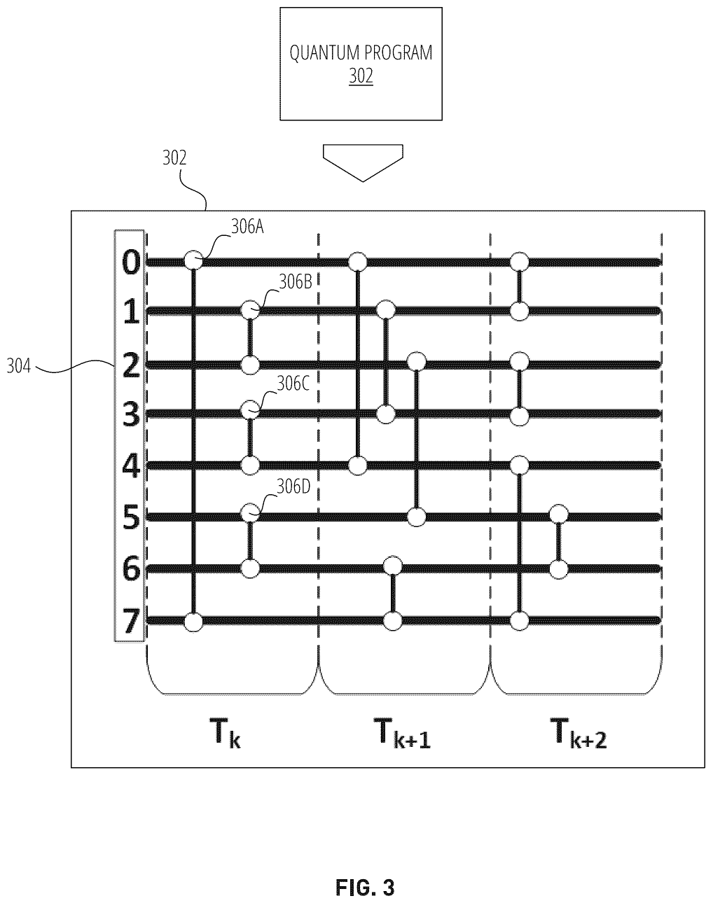

FIG. 3 illustrates an example data architecture for compiling at least one quantum program in a 2D quantum computing environment in accordance with at least one example embodiment of the present disclosure. For example, in some embodiments the quantum program as depicted and described is compiled in an example computing environment, such as a software environment maintained by one or more classical computing components, into at least one time step defining operations performable within in a 2D quantum computing environment. It will be appreciated that the quantum program, determination of qubit pairs from the quantum program, and compilation of the quantum program, is independent from the device on which the quantum program is targeted to be run. In some embodiments, one or more of the illustrated elements is embodied by one or more data object(s) and/or other data values maintained by a computing system, such as the controller 30 embodied by the specially configured apparatus 200. In this regard, each illustrated element may be embodied, and/or manipulated, using hardware, software, firmware, and/or a combination thereof.

In some embodiments, a computing entity may be used to generate a quantum program 302 and/or submit the quantum program 302 for compilation and/or execution. The quantum program 302 may be written in any of a myriad of quantum computing programming languages and embody any number of commands to be performed via a quantum computer. In this regard, the quantum program 302 may embody user-submitted instructions, computer program code, or other representations to be executed via the quantum computer, for example by first compiling the quantum program into at least one set of executable instructions that the quantum computer, or particular quantum components thereof, can process and/or execute. In this regard, the quantum computer may implement the quantum program by initializing any number of qubits managed by the quantum components of the quantum computer, and/or performing operations using the qubits, such as execution of logical gate performed using qubit pairs and/or individual qubits as the inputs to the logical gates.

In some such embodiments, the quantum program 302 includes, and/or is embodied by, one or more sets of qubit pairs to be executed at various time steps. An example quantum program 302 is depicted, where the quantum program 302 is embodied by one or more sets of qubit pairs, each set of qubit pairs comprising pairs of qubits from the qubit set 304 to be executed at a plurality of time steps. As illustrated, the quantum program 302 is associated with a qubit set 304. The qubit set 304 includes 8 qubits, each qubit identified by a zero-based qubit index ranging from 0 to 7. Each qubit represented in the qubit set 304 may correspond to a qubit physically maintained in a corresponding quantum computing environment. Accordingly, the depicted qubit set 304 may correspond to an 8-qubit quantum computer having 8 defined regions on a 2D ion trap. It should be appreciated that, in other embodiments, any number of qubits may be utilized.

The quantum program 302 is broken down into a plurality of time steps, specifically time steps Tₖ, Tₖ₊₁, and Tₖ₊₂. Each of the time steps is associated with a set of qubit pairs, the qubit pairs comprising pairs of the qubits to undergo gating at the corresponding time step. For example, as illustrated, at time slice Tₖ, the qubit pairings include qubit pair 306A that pairs qubit 0 with qubit 7, qubit pair 306B that pairs qubit 1 with qubit 2, qubit pair 306C that pairs qubit 3 with qubit 4, and qubit pair 306D that pairs qubit 5 with qubit 6 (collectively, the qubit pairs 306A-306D referred to as “set of qubit pairs”). In this regard, each qubit pair may be associated with one or more logical gates to be executed at the time step. For example, as illustrated, qubit pair 306C may represent qubit 3 and qubit 4 as inputs to a particular logic gate to be executed during time step Tₖ, qubit pair 306D may represent qubit 5 and qubit 6 as inputs to another logic gate to be executed during time step Tₖ, and so on, while such qubits may be utilized in different qubit pairs during another time slice (e.g., qubit 2 and qubit 5 as inputs to another logic gate to be executed during time step Tₖ₊₁). In this regard, the plurality of qubit pairs for each time slice may embody all qubit pairings that make up the quantum program 302.

Execution of a logical gate may require that the qubit pair, embodying inputs to the logical gate, be located at adjacent positions within the quantum computing environment during the corresponding time slice to enable execution of the logical gate. In this regard, the qubits may require repositioning within a quantum computer to position the qubits of a particular qubit pair adjacent to one another for execution of a corresponding logic gate. In various embodiments, qubit positions are fixed, and the quantum information stored in fixed-position qubits may require repositioning within the set of fixed qubits within a quantum computer to position the quantum information of a pair of qubits to be adjacent to one another for execution of a corresponding logic gate.

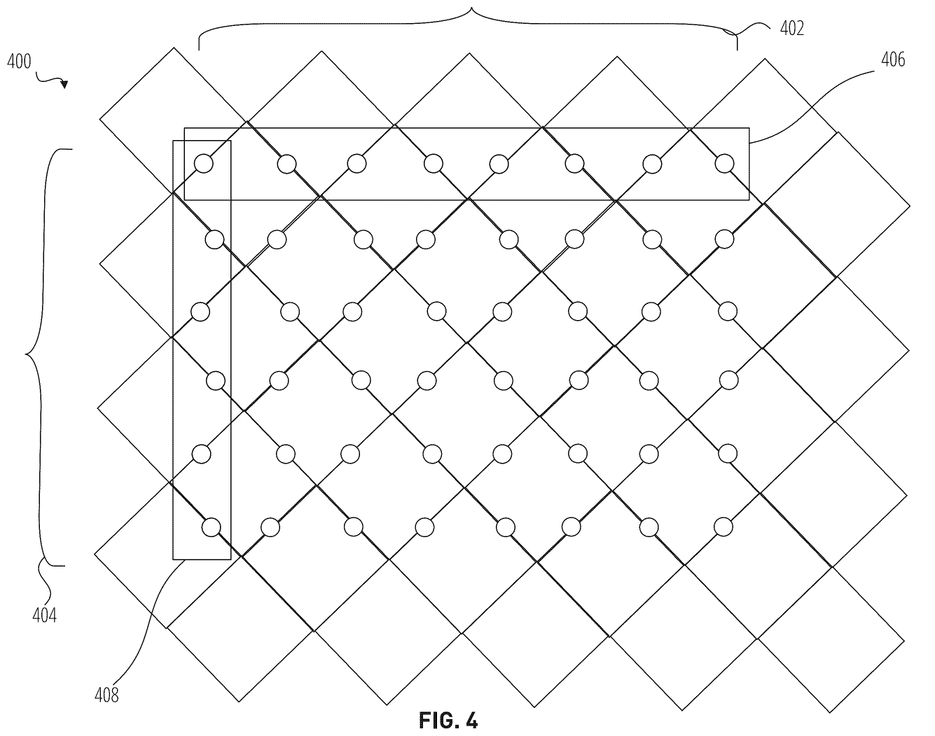

In this regard, FIG. 4 illustrates another example computing environment for instruction compilation for at least one time slice in a one-dimensional quantum computing environment, in accordance with at least one example embodiment of the present disclosure. Specifically, the example computing environment includes a plurality of data objects that may be identified, maintained, and/or utilized for positioning qubits based on a qubit pairing set for a particular time slice. The data object(s) may further be maintained by a computing system, such as the controller 30 embodied by the specially configured apparatus 200. In this regard, each illustrated element may be embodied, and/or manipulated, using hardware, software, firmware, and/or a combination thereof.

FIG. 4 illustrates a visualization of qubits in an example 2D quantum computing environment in accordance with at least one example embodiment of the present disclosure. Specifically, FIG. 4 depicts an example 2D quantum computing environment 400. In some embodiments, the 2D quantum computing environment is maintained within a quantum computer by one or more quantum components. For example, in some embodiments the 2D quantum computing environment 400 is maintained via an ion trap within a chamber or other vacuum and manipulated via one or more lasers or other manipulation sources controlled via a controller. In some embodiments, the 2D quantum computing environment 400 is maintained via the quantum computer 102 as depicted and described with respect to FIG. 1.

The 2D quantum computing environment 400 includes a number of columns 402 and a number of rows 404. Specifically, as depicted, the 2D quantum computing environment 400 includes 8 columns and 6 rows. In this regard, each combination of row and column corresponds to a different position in the 2D quantum computing environment. In some embodiments, each position is represented by a tuple of (row_number, column_number), and/or a single linear position index. For example, the position index (0, 0) in some embodiments corresponds to the top left position depicted in the 2D quantum computing environment 400, and (7, 5) corresponds to the bottom right position depicted in the 2D quantum computing environment 400. The position index (0, 0) in some embodiments similarly corresponds to linear position index 0, and (7, 5) corresponds to linear position index 47, where the linear position index represents a continual count of position per row defined by (r*C)+c, where r represents the row of the position, C represents the total number of columns per row, and c represents the column of the position.

2D quantum computing environment 400 is configured to maintain a number of qubits. As depicted, the 2D quantum computing environment 400 is full such that a qubit is stored at each position in the environment. The qubits may be manipulated throughout the 2D quantum computing environment 400 to enable transfer of such qubits between positions through any number of operations. For example, in some embodiments the qubits are swapped between adjacent positions to enable traversal of any such qubits throughout the 2D quantum computing environment 400. In other embodiments, the 2D quantum computing environment 400 may store a lesser number of qubits and may be similarly manipulated. In circumstances where a position in the 2D quantum computing environment 400 is not storing a qubit or otherwise empty, a qubit may be manipulated to traverse to that position where the source position remains empty upon completion of the traversal. Such operations may be treated as a swap with the empty position for purposes of determining how to manipulate the 2D quantum computing environment, for example by compiling a quantum program into a set of swap-or-not operations for execution. Some embodiments need not perform any manipulation actions in circumstances where only a single qubit is being repositioned.

Each position may be manipulated for traversal to an adjacent position in any direction. In this regard, each combination of row and column may be repositioned to the same column plus-or-minus one row, or the same row plus-or-minus one column. In this regard, position (r, c) may be repositioned to any of the positions represented by (r+1, c), (r−1, c), (r, c+1), or (r, c−1), for all positions that exist within the boundaries of the 2D quantum computing environment 400 (e.g., r exists in the range of [0, 5] and c exists in the range of [0, 7]).

As illustrated, 2D quantum computing environment 400 is depicted on a rotated grid. In this regard, a quantum computer, such as the quantum computer 102, may be configured to reposition a qubit from a source position to a target position utilizing a particular junction. In this regard, the swaps of qubits may be performed freely without blockages occurring at such junctions. It will be appreciated that any other arrangement of positions in the 2D quantum computing environment may be utilized without deviating from the spirit and scope of this disclosure.

In some embodiments, movements of qubits based on optimized compilation of a quantum program for a 2D quantum computing environment is defined by a set of column movements and a set of row movements, where each movement in some embodiments represents a swap with an adjacent position. For example, in some embodiments, a particular column is sorted based on a target row assignment for each of the rows in the 2D quantum computing environment 400. For example, qubits 408 define a first column of the 2D quantum computing environment 400. The qubits defining the first column may be sorted utilizing a number of swap commands that facilitate movement of the qubits 408 from their starting positions to target rows defined by a determined set of target row assignments as depicted and described herein. Additionally or alternatively, in some embodiments, the qubits 406 define a first row of the 2D quantum computing environment 400. The qubits of the first row may be sorted after all qubits reach a target row, where each row is then sorted utilizing a number of swap commands that facilitate movement of the qubits 406 from their starting positions to target columns of the target row. In this regard, it should be appreciated that each column may be independently sorted to reposition qubits of that column to their target rows in a similar manner as described with respect to qubits 408, and each row may subsequently be independently sorted to reposition qubits of that row to their target columns in a similar manner as described with respect to qubits 406.

Though embodiments of the present disclosure are described with respect to identifying target rows, then identifying target columns, it will be appreciated that in other embodiments column and row assignments may be swapped. In some such embodiments, target columns may first be assigned and subsequently target rows may then be assigned. In such embodiments, the target column assignments may be generated via the methodologies discussed further herein for assigning target rows, and the target row assignments may be generated via the methodologies discussed herein for assigning target columns. Such embodiments include circumstances where vertical adjacency of qubits is required to perform logical gates in a particular quantum computer, for example as opposed to horizontal adjacency. In this regard, the use of “row” and “column” may be interchanged for a particular 2D quantum computing environment without deviating from the scope and spirit of the innovation.

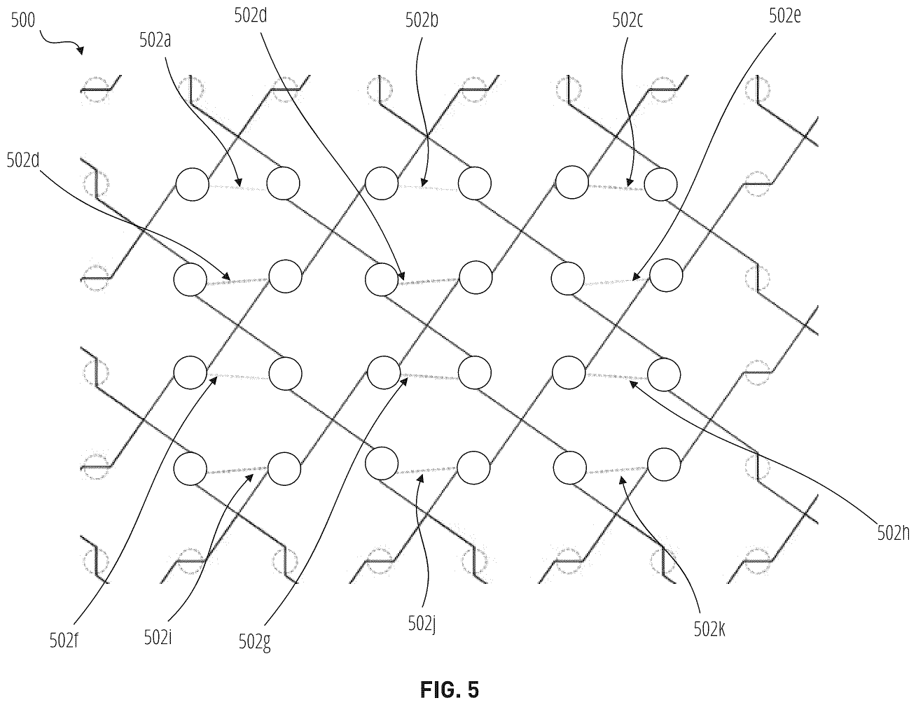

FIG. 5 illustrates a visualization of qubits sorted to adjacency for gating in a 2D quantum computing environment in accordance with at least one example embodiment of the present disclosure. Specifically, FIG. 5 depicts an example sorted 2D quantum computing environment 500. The sorted 2D quantum computing environment 500 depicts a plurality of qubits sorted into target positions based on qubit pairs. As illustrated, FIG. 5 depicts the qubit pairs 502a-502k, where each qubit pair includes two adjacent qubits connected by a line depicted for visualization only and not defining any operational aspect or component of the actual quantum computer.

The qubit pairs 502a-502k may be sorted from their starting positions to such target positions represented in the sorted 2D quantum computing environment 500 based at least in part on the efficient compilation of a quantum program as depicted and described herein. In this regard, the repositioning of qubits in the 2D quantum computing environment may occur via any number of swap-or-not operations performed in parallel. The parallel nature of swap-or-not operations refers to the ability of two qubits to be swapped during the same time interval where two other qubits are swapped, enabling each qubit to undergo a swap if needed during swapping of other qubits simultaneously or otherwise in parallel during the same time step.

The adjacent nature of each qubit pair enables execution of logical gates on each qubit pair simultaneously and/or otherwise in parallel during a particular time step before one or more qubits may be repositioned again for gating together with another qubit in a subsequent time step. Such repositioning and execution of logical gates may continue to be performed for any number of time steps required for parallel execution of such logical gates defining a quantum program.

In some embodiments, a quantum program is efficiently compiled utilizing an efficient compilation algorithm comprising a multi-sub-step process for each parallel time step required to execute the quantum program. For example, the quantum program may be divided into time steps in circumstances where a particular qubit is required in multiple qubit pairs corresponding to logical gates to execute as part of the quantum program. Additionally or alternatively, a qubit may be utilized for one or more sequential operations where one operation cannot begin until completion of the next, requiring multiple time steps to accomplish such operations in sequence. In this regard, a quantum program may be divided into a set of time steps, each associated with a different set of qubit pairs corresponding to logical gates for execution during that time step, and the efficient compilation algorithm may be performed for each time step determined for the quantum program.

In some embodiments, the efficient compilation algorithm begins with an optional single pre-processing step and two full steps. Each step may define a different sub-algorithm that determines a set of swap-or-not operation operations to perform on the qubits to reach a particular sorting objective. The sets of swap-or-not operations generated for each step may be combined to determine a complete set of swap-or-not operations defining all swap operations determined to efficiently sort a set of qubits from their starting positions to determined target positions that enables gating at a particular time step defined for at least a portion of a quantum program. In this regard, a quantum program may be similarly compiled into a set of sets of swap-or-not operations, each sub-set corresponding to a particular time step and representing a set of swap-or-not operations to perform to enable execution of logical gates in parallel via the quantum computer during the particular time step.

The pre-processing step of the efficient compilation algorithm in some embodiments includes an algorithm for ensuring that, for a particular time step, a set of starting positions for a set of qubits corresponding to a set of qubit pairs satisfies an even-odd constraint. For example, in some embodiments, the efficient compilation algorithm comprises processing a set of qubit pairs and corresponding to the set of starting positions to determine if any of the qubit pairs fails to satisfy the even-odd constraint. In some embodiments, for example, this step includes checking the starting positions corresponding to the qubits of each qubit pair to determine whether each qubit pair includes an even column index and an odd column index. In this regard, each qubit pair must be associated with opposite column parity for a given time step to satisfy the even-odd constraint.

In a circumstance where embodiments determine that the qubit pairs do not satisfy the even-odd constraint, for example because at least one qubit pair is not associated with opposite column parity in the set of starting positions, the sub-step continues to convert the set of starting positions. In this regard, embodiments may utilize the set of starting position as an initial starting positions set, and convert the initial starting positions set to an updated starting positions set that satisfies the even-odd constraint.

Some embodiments process the initial starting positions set to determine one or more candidate swappable paths based on the initial starting positions set and set of qubit pairs. For example, some embodiments identify candidate swappable paths that connect a non-compliant terminal to another non-compliant terminal or terminal qubit. The non-compliant terminals may represent the position indices of a qubit pair that does not satisfy the even-odd constraint, for example from including qubits associated with even-even position indices, odd-odd position indices, and/or the like. Some embodiments generate a graph comprising each candidate swappable path, where the graph includes a source node connected to a set of nodes representing each first non-compliant terminal of each candidate swappable path. For each node in the set representing a non-compliant terminal, the node is connected with an intermediary path to another node representing the second terminal of each candidate swappable path corresponding to the first node or terminal qubit. The nodes corresponding to the second terminal of each candidate swappable path embodies a second set of nodes connected to a final target node. In this regard, the intermediary qubit pair from the first non-compliant terminal to the second terminal may be condensed to a single edge, where the weight of the edge represents the swap cost of performing a swap operation at each position along the swappable path. The graph is then processable to select one or more of the candidate swappable paths to convert the initial starting positions set. For example, in some embodiments the graph is processable utilizing a modified Suurballe's algorithm and/or other efficient disjoint path algorithm. The resulting at least one swappable path identified converts the initial starting positions set to a set of starting positions that satisfies the even-odd constraint.

In the first full step, the efficient compilation algorithm proceeds with generating a set of target row assignments. Upon generating the target row assignments, a set of swap-or-not operations is determined that traverses the qubits from their starting positions represented in the starting position sets to the target rows represented in the set of target row assignments. In this regard, the set of swap-or-not operations represents performed swaps of an even-odd transposition sort to reposition the qubits from their starting positions to their target positions within the current column for the qubit.

In some embodiments, the first full step includes a sub-algorithm that generates the set of target row assignments and corresponding set of swap-or-not operations that repositions the qubits reach said target row assignments. The sub-algorithm in some embodiments assigns a right target column to be right-adjacent to a corresponding even column for a set of qubit pairs satisfying the even-odd constraint. In some such embodiments, the sub-algorithm includes generating a graph representing a first adjacency or corresponding numerical parity (e.g., even column indices) as a first set of nodes connected to a second set of nodes representing a second adjacency or corresponding other numerical parity (e.g., odd column indices). The graph is further generated including, for each qubit pair of the set of qubit pairs for a particular time step, an edge connecting a node from the first set to node from the second set. The node from the first set corresponds to the even column index of the starting position for one of the qubits of the qubit pair (e.g., the even column index qubit of an even-odd qubit pair), and the node from the second set corresponds to the odd column index of the starting position for the other qubit of the qubit pair (e.g., the odd column index qubit of an even-odd qubit pair). Weights of the edges may be set based on a swap cost of assigning each qubit in the qubit pair from its current row to the target row for the current target row assignment for all available candidate target rows. A perfect matching algorithm may then be utilized to process the graph to perform a minimum-weight perfect matching for all weighted graphs associated with all candidate target rows. The perfect matching having the maximum minimum-total-weight may be selected amongst the set of available candidate target rows and the process repeated until all target rows are assigned. In this regard, qubits of a particular qubit pair are assigned to the same target row in the target row assignments; no more than one column is assigned for every target row; and no more than one starting row within each column is assigned to a target row. In this regard, contention for common intermediate positions is avoided, and qubits may move from their updated starting positions set to their target positions with no more than one qubit ever occupying a single position at a time.

Once a set of target row assignments is completed for all rows, or all qubits of the qubit set, a corresponding set of swap-or-not operations for positioning the qubits from starting positions to rows based on the target row assignments is generated. In some embodiments, an even-odd transposition sort algorithm is performed to determine swap-or-not operations for repositioning a qubit from its starting position row index to the target row represented in the target row assignment. A set of swap commands is represented based on each swap performed during the even-odd transposition sort. In this regard, the first full stage is completed in maximum R parallel swap steps, where R is the number of rows in the 2D quantum computing environment.

The efficient compilation algorithm then proceeds with the second full step. The second full step comprises a second sub-algorithm for generating a set of target column assignments for the set of qubit pairs. In some embodiments, the second full step relies on the intermediary positions of each qubit, where the intermediary position indices for a qubit represents the row of the qubit upon repositioning based on the target row assignments. For example, the second algorithm may determine a target column index for each qubit in a row. Upon generating the target column index for each qubit in a row, a set of swap-or-not operations is determined that traverses qubits from its intermediary position determined via the first step to the target position determined at the second step. In this regard, the set of swap-or-not operation represents performed swaps of an even-odd transposition sort to reposition each qubit from its current column to a target column within the current row represented in the intermediary position generated at the first full step.

In some embodiments, a particular custom even-odd transposition sort algorithm is performed. For example, in some embodiments, an even-odd transposition sort is performed that sorts odd-column position indices only and stops half-way through the sort. Based on the result of the halfway point of the sort, the target position for each odd-column qubit of each qubit pair is assigned to the index identified in the sort. The target position for each counterpart even-column qubit of each qubit pair is assigned to the position index adjacent to the corresponding position index identified for the odd-column position index of that qubit pair. These final target positions for each qubit represent a target column assignment for a particular row. Such a process may be repeated for each row in the 2D quantum computing environment. Once the target column assignment is generated including a target position for each qubit in a row, another iteration of even-odd transposition sort may be performed to determine a set of swap-or-not operations that reposition the qubits from their intermediary positions to the final target positions represented by the target column assignments. Non-limiting examples of performing the custom even-odd transposition sort algorithm for a particular row is depicted and discussed with respect to compilation in a 1D quantum computing environment in U.S. application Ser. No. 17/319,511, filed May 13, 2021, and titled “APPARATUSES, COMPUTER-IMPLEMENTED METHODS, AND COMPUTER PROGRAM PRODUCTS FOR INSTRUCTION COMPILATION FOR AT LEAST ONE TIME SLLICE IN A ONE-DIMENSIONAL QUANTUM COMPUTING ENVIRONMENT,” the contents of which are incorporated by reference herein in their entireties. In this regard, the second full stage is completed in a maximum of 2*((C/2+1)/2)+1 parallel swap steps, where C is the number of columns in the 2D quantum computing environment.

In this regard, the pre-processing step is completed in a maximum of one parallel swap step. The first full step is completable in maximum R parallel swap steps. The second full step is completable in a maximum of 2*((C/2+1)/2)+1 parallel swap steps. Accordingly, the efficient compilation algorithm is completable in a maximum of R+2*((C/2+1)/2)+2 parallel swap steps. Such implementations are improved over random, naïve, and/or other generic methodologies that reposition qubits for gating.

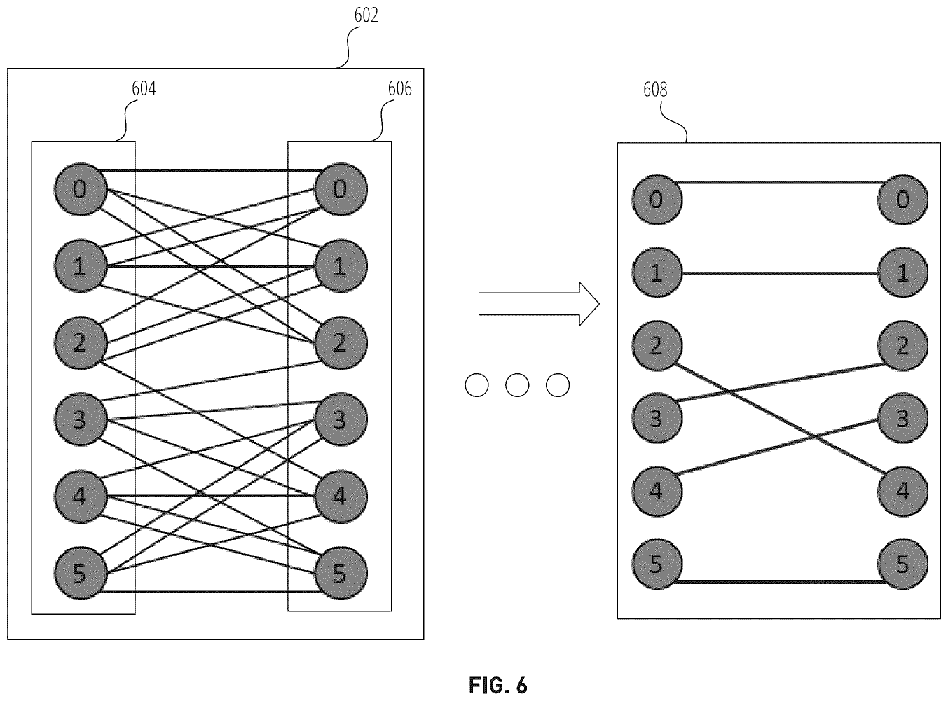

FIG. 6 illustrates a visualization of an iteration of a perfect matching algorithm performed during target position assignment of qubits in accordance with at least one example embodiment of the present disclosure. Specifically, FIG. 6 depicts a perfect matching 608 representing a target row assignment representing qubit pairs for assignment to a particular target row as generated from a graph 602. Some embodiments generate a perfect matching algorithm during a first full step to generate each target row assignment for a set of target row assignments.

The graph 602 includes a first node set 604. In some embodiments, the first node set 604 includes a node corresponding to each index of a first parity in the 2D quantum computing environment. For example, in some embodiments, the first node set 604 includes a node corresponding to each even column index in the 2D quantum computing environment, such as 0, 2, 4, 6, 8, and 10 in a 2D quantum computing environment that has 12 total columns. In this regard, each node may correspond to a particular numbered slot or index in the ordering of even column indices represented by 2(n), where n is the number of the node in the ordering, such that node 0 in the first node set 604 corresponds to column 0, node 1 in the first node set 604 corresponds to column 2, node 2 in the first node set 604 corresponds to column 4, and so on for all even columns of the 2D quantum computing environment.

The graph 602 further includes a second node set 606. In some embodiments, the second node set 606 includes a node corresponding to each index of a second parity (e.g., the opposite parity as first node set 604) in the 2D quantum computing environment. For example, in some embodiments, the second node set 606 includes a node corresponding to each odd column index in the 2D quantum computing environment, such as 1, 3, 5, 7, 9, and 11 in the 2D quantum computing environment that has 12 total columns. In this regard, each node may correspond to a particular numbered slot or index in the ordering of odd column indices represented by 2(n)+1, where n is the number of the node in the ordering, such that node 0 in the second node set 606 corresponds to column 1, node 1 in the second node set 606 corresponds to column 3, node 2 in the second node set 606 corresponds to column 5, and so on for all odd columns of the 2D quantum computing environment.

In some embodiments, the graph 602 is created including an edge that connects a first node from the first node set 604 with a second node of the second node set 606, where the first node and the second node correspond to qubits of a particular qubit pair for a time step. For example, a qubit pair may be determined to include a first qubit at a first position index representing a first column index and a second qubit at a second position index representing a second column index, where the first column index or the second column index is even, and the other column index is odd. In this regard, the first node from the first node set 604 corresponds to the even column index of the first qubit in the qubit pair and the second node from the second node set 606 corresponds to the odd column index of the second qubit in the qubit pair. Such edge creation may be repeated for each qubit pair determined for a particular time step, such that each first node representing an even column index in the first node set 604 includes an edge corresponding to each qubit pair having a first qubit associated with the even column index corresponding to the first node in the first node set 604 that is connected to each particular second node in representing an odd column index of the other qubit in the qubit pair. Such even-odd connections are maintained based on satisfaction of the even-odd constraint in the initial starting positions set or as updated in the pre-processing step of the efficient compilation algorithm described herein.

Once the graph 602 is constructed, some embodiments process the graph 602 to select particular edges corresponding to particular nodes representing qubit position indices for assigning to a particular target row assignment. In some embodiments, for example, the nodes are selected iteratively utilizing a perfect matching algorithm. In this regard, in some embodiments, the perfect matching algorithm is run on the graph 602 to generate and/or otherwise identify the perfect matching 608. It will be appreciated that any known perfect matching algorithm may be utilized to process the graph 602 to generate the perfect matching 608. As illustrated, the perfect matching 608 includes edges connecting:

node 0 of the first node set 604 with the second node set 606, for example corresponding to a first qubit pair having a first qubit at even column index 0 and a second qubit at odd column index 1,

node 1 of first node set 604 with node 1 of second node set 606, for example corresponding to a second qubit pair having a first qubit at even column index 2 and a second qubit at odd column index 3,

node 2 of first node set 604 with node 4 of second node set 606, for example corresponding to a third qubit pair having a first qubit at even column index 4 and a second qubit at odd column index 9,

node 3 of first node set 604 with node 2 of second node set 606, for example corresponding to a fourth qubit pair having a first qubit at even column index 6 and a second qubit at odd column index 5,

node 4 of first node set 604 with node 3 of second node set 606, for example corresponding to a fifth qubit pair having a first qubit at even column index 8 and a second qubit at odd column index 7,

node 5 of first node set 604 with node 5 of second node set 606, for example corresponding to a sixth qubit pair having a first qubit at even column index 10 and a second qubit at odd column index 11.

Some embodiments assign a weight to each edge in the graph 602. For example, in some embodiments, the weight of each edge is defined based on a number of parallel swap steps required to sort the qubits from their set of starting positions to a particular row. The number of steps to sort in some embodiments is determined utilizing an even-odd transposition sort. In other embodiments, the weight of each edge is based on the distances from the starting position rows to the row for assigning. In other embodiments, a weight is applied to an edge utilizing another distance-based and/or swap savings-based heuristic. In this regard, a histogram of distances may be utilized. In some embodiments, a highest weight of a set of weights (e.g., defined by one or more heuristics or other weighting algorithms) is assigned to a weigh to reduce the negative impact of locking qubits to an intermediary row that causes downstream effects increasing the total overall number of swap operations performed to reposition all the qubits in accordance with the target row assignments. For example, using the histogram of distances for both qubits in a pair to a target row, which encapsulates two distances (e.g., the distances of both qubits), the maximum distance may be considered and assigned based on the highest weight. In one example context, the min-weight perfect matching algorithm relies on the ability to sum the weights and compare total sums, which may further be encapsulated within the histogram of distances more generally to include two or more distances.

The perfect matching 608 is created in a manner such that each node from the first node set 604 is connected to only one other node in the corresponding perfect matching 608. Accordingly, a target row assignment may then be generated that maps the qubit pairs corresponding to each of the edges to a particular target row while simultaneously ensuring that each column of that target row is only assigned to a single qubit index. Once a qubit index (or corresponding qubit, depending on representation) is assigned to a particular target row, that row may be removed from consideration and edges corresponding to the particular qubits or corresponding qubit indices assigned to that row in the target row assignment are removed or otherwise marked to prevent further consideration in processing the graph 602. The graph 602 may subsequently be processed via a subsequent iteration of the perfect matching algorithm. Such iterations may continue until each row is assigned.

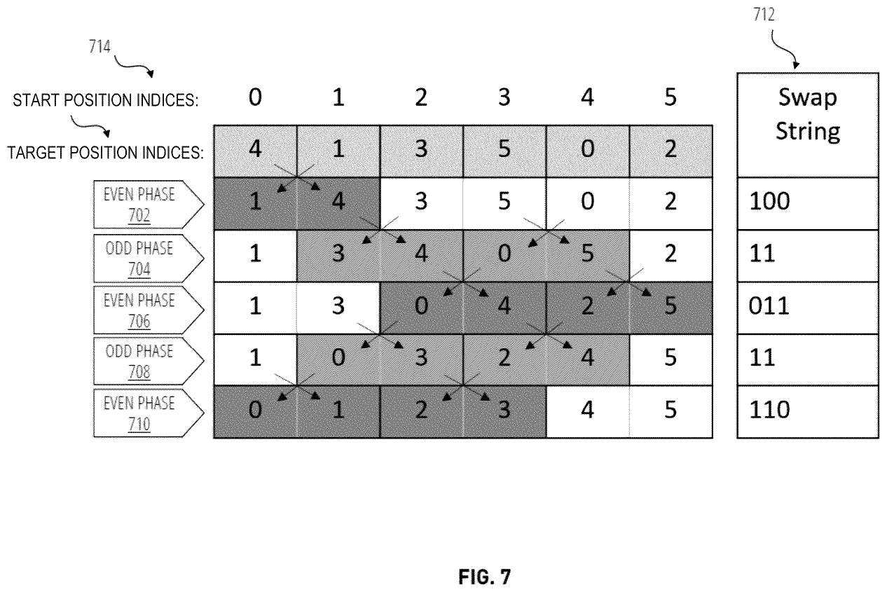

FIG. 7 illustrates a representation of swap-or-not operations in a 2D quantum computing environment in accordance with at least one example embodiment of the present disclosure. Specifically, FIG. 7 depicts multiple parallel swap steps representing swap-or-not operations generated based on a performed even-odd transposition sort in 1D to be applied to individual columns in the first full step and to individual rows in the second full step. The even-odd transposition sort is performed for sorting a vector of target position indices 716 indexed by start position indices 714. In some embodiments, for each column in the 2D quantum computing environment, the target position indices 716 corresponds to a set of target row indices and the start position indices 714 correspond to a set of start row indices as generated by the set of solutions of the perfect matching problem described herein. In some embodiments, for each target row in the 2D quantum computing environment, the target position indices 716 corresponds to a set of target columns for a qubit set repositioned (e.g., identified upon after the first full step of generating target row assignments) and the start position indices 714 corresponds to a set of start columns (e.g., generated via a second full step of the efficient compilation algorithm as depicted and described herein). In this regard the even-odd transposition sort methodology as depicted and discussed may be utilized in any of the circumstances described herein.

The even-odd transposition sort performs swaps for particular indices based at least in part on a particular phase. For example, in some embodiments, the even-odd transposition sort begins with an even phase 702. During the even phase, the even-odd transposition sort compares values at each even index with a second value at a corresponding higher odd index adjacent to the even index. For example, the value at index 0 of the vector is compared with the value at index 1, and a swap command is generated for such indices in a circumstance where the value at index 1 is determined lower than the value at index 0. Similarly, the value at index 2 is compared to the value at index 3, and a swap command is generated for such indices in a circumstance where the value at index 3 is determined lower than the value at index 2. Such comparisons may continue for each even and subsequent odd index pair in the vector.

The even-odd transposition sort then proceeds to an alternative phase, for example the odd phase 704. During the odd phase, the even-odd transposition sort compares values at each odd index with a second value at a corresponding higher even index adjacent to the odd index. For example, the value at index 1 of the vector is compared with the value at index 2, and a swap command is generated for such indices in a circumstance where the value at index 2 is determined lower than the value at index 1. Similarly, the value at index 3 is compared to the value at index 4, and a swap command is generated for such indices in a circumstance where the value at index 4 is determined lower than the value at index 3. Such comparisons may continue for each odd and subsequent even index pair in the vector.

The even-odd transposition sort continues for any number of parallel swap steps until the vector is sorted (e.g., the target position indices 716 reach the corresponding positions in the start position indices 714, or otherwise is in sorted order). As illustrated, for example, the even-odd transposition sort alternates between the even phase 706, the odd phase 708, and the even phase 710. Upon completion of the even phase 710, embodiments determine that the values are properly sorted, and thus no further swap steps are performed.

In some embodiments, a parallel swap string 712 representing a set of swap-or-not operations to perform is generated as each phase of the even-odd transposition sort is performed. For example, in some embodiments, the parallel swap string 712 includes a substring representing a sub-set of swap-or-not operations to perform for each phase performed. The parallel swap string for each phase may include a number of bits, or other values, representing each value corresponding to each index of the same parity of the current phase (e.g., a number of bits equaling the number of even indices in the even phase, and a number of bits equaling the number of odd indices in the odd phase). The value of each bit at a particular index represents whether a swap operation is determined to be performed for that index and the corresponding adjacent index (e.g., a ‘1’ for indicating a swap operation is determined to be performed, and a ‘0’ indicating that a swap operation is determined not to be performed. For example, in the first phase the parallel swap string 712, three bits are indicated corresponding to each of the even indices (0, 2, and 4), with the bits having values of ‘1,’ ‘0’, and ‘0’ respectively to indicate that the first even index should be swapped with its corresponding odd index, and the remaining even indices should not be swapped. The swap parallel swap string 712 may represent a set of swap-or-not operations, with one or more subsets thereof representing the particular swap-or-not operations that are performable in parallel as part of a particular phase. In this regard, the parallel swap string 712 in some embodiments is processable to determine a particular set of swap operations to be performed to bring the qubits at the particular positions into optimized objective position indices.

### Example Processes of the Disclosure

Having described example systems and apparatuses, data environments, data architectures, and the like in accordance with the disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof.

Although the example processes depict a particular sequence of operations, the sequence may be altered without departing from the scope of the present disclosure. For example, some of the operations depicted may be performed in parallel or in a different sequence that does not materially affect the function of the processes.

The blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

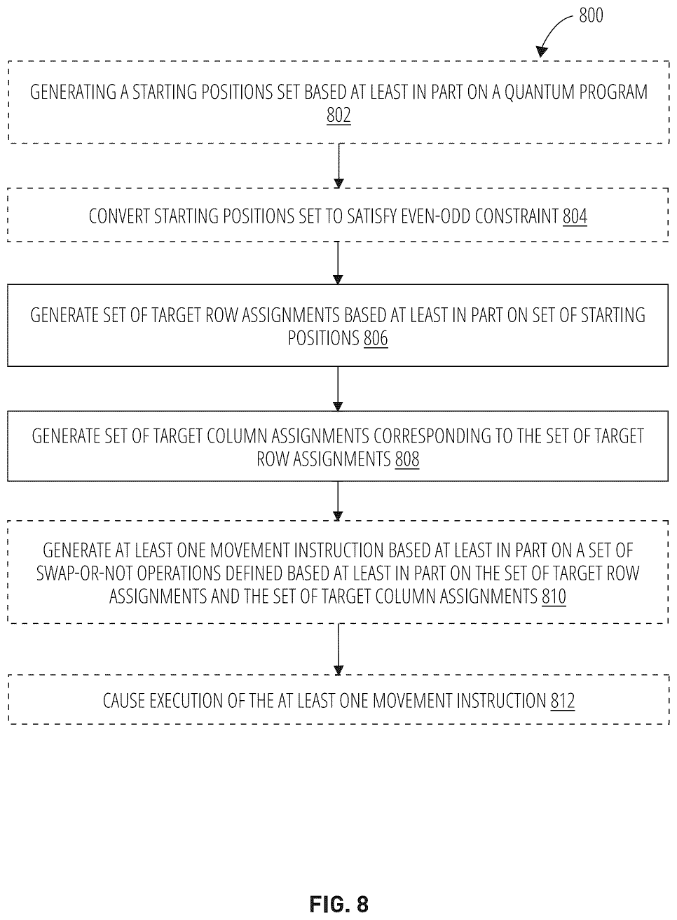

FIG. 8 illustrates a flowchart including example operations of a process for generating a set of target positions for a set of qubits in accordance with at least one example embodiment of the present disclosure. Specifically, FIG. 8 depicts an example process 800. In some embodiments, the process 800 is executable as computer program code stored on a non-transitory computer-readable storage medium of a computer program product configured for execution to perform the process as depicted and described. Alternatively or additionally, in some embodiments, the process 800 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one computing entity 10, quantum components of a quantum computer, and/or the like, to perform one or more of the operation(s) as depicted and described. For purposes of simplifying the description, the process 800 is described as performed by and from the perspective of the apparatus 200.

Although the example process 800 depicts a particular sequence of operations, the sequence may be altered without departing from the scope of the present disclosure. For example, some of the operations depicted may be performed in parallel or in a different sequence that does not materially affect the function of the process 800. In other examples, different components of an example device or system that implements the process 800 may perform functions at substantially the same time or in a specific sequence.

According to some examples, the process includes generating a starting positions set based at least in part on a quantum program at optional operation 802. For example, in some embodiments the apparatus 200 processes the quantum program to derive a set of qubit pairs at one or more time steps. The time steps may be determined based on whether operations to be performed as part of the quantum computer (e.g., execution of logic gates) involve the same qubits. The apparatus 200 may determine the starting positions set for a time step based on the current positions of the qubits at the start of the time step, and/or representing the positions of the qubits at the end of a previous time step. In some embodiments, the quantum program is generated via the apparatus 200. In other embodiments, the apparatus 200 receives the quantum program, for example from a computing entity 10 utilized to generate the quantum program.

According to some examples, the process includes converting starting positions set to satisfy even-odd constraint at optional operation 804. In some embodiments, the apparatus 200 processes the starting positions set to determine that the starting positions set does not satisfy the even-odd constraint. For example, in some embodiments the apparatus 200 processes the starting positions set to determine whether each qubit pair is associated with an even position index (i.e., having an even column index) and an odd position index (i.e., having an odd column index). The apparatus 200 may determine that the starting positions set does not satisfy the even-odd constraint in a circumstance where at least one qubit pair does not satisfy the even-odd constraint. In some embodiments, the process includes determining that the set of starting positions satisfies the even-odd constraint, for example by satisfying the even-odd constraint for each qubit pair, and thus the conversion at optional operation 804 is optionally skipped.

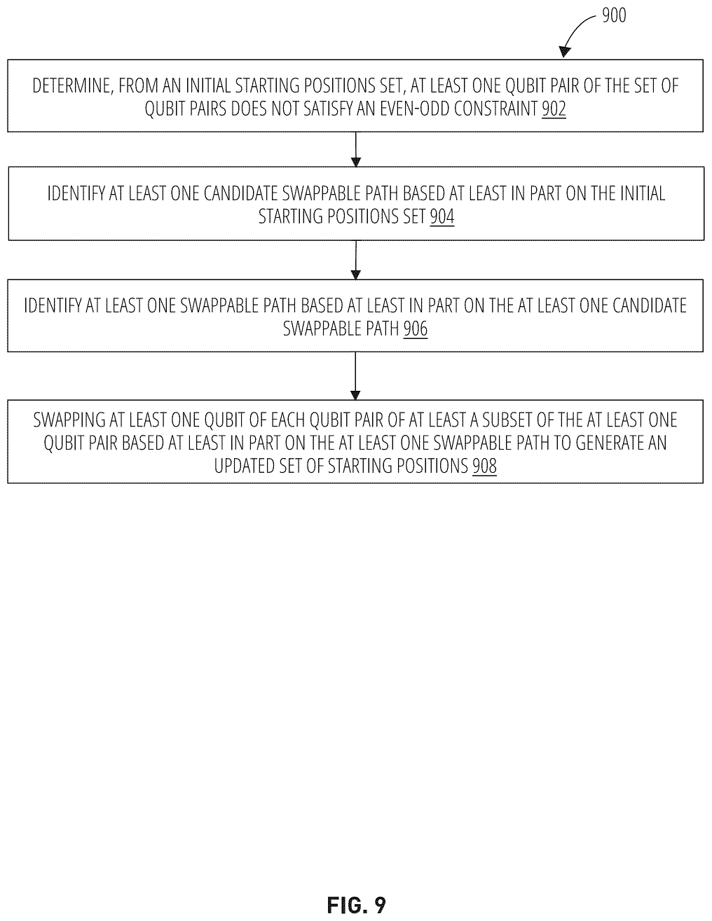

In some embodiments, the apparatus 200 converts the starting positions set utilizing the starting positions set as an initial starting positions set. The apparatus 200 then processes the initial starting positions set to generate an updated starting positions set that satisfies the even-odd constraint. In some embodiments, the apparatus 200 processes the initial starting positions set to identify at least one candidate swappable path. In some embodiments, a swappable path represents a set of swaps performable to convert one or more non-compliant terminals (e.g., a qubit pair associated with even-even position indices or odd-odd position indices) to satisfy the even-odd constraint. Additionally or alternatively, in some embodiments, a swappable path represents a closed cycle path or other path between qubits of adjacent position indices and determined to provide a swap savings as compared to the initial starting positions set. A non-limiting example sub-process for converting the starting positions set is depicted and described herein with respect to FIG. 9.

The generated conversion of the initial starting positions set to the updated starting positions set in some embodiments is performable in a single time step. In this regard, the processing of the one or more swappable paths may indicate one or more swap-or-not operations to perform for one or more qubits in the set of starting positions. The determined swap-or-not operations for each qubit may be performed in parallel to ensure that all swaps, where determined to improve the overall number of swaps associated with the updated starting positions set and/or to update the initial starting positions set to satisfy the even-odd constraint, are completed within a single time step. In some such embodiments, the apparatus 200 performs the conversion of the starting positions set before further processing the updated starting positions set to perform target position assignments for a particular time step.

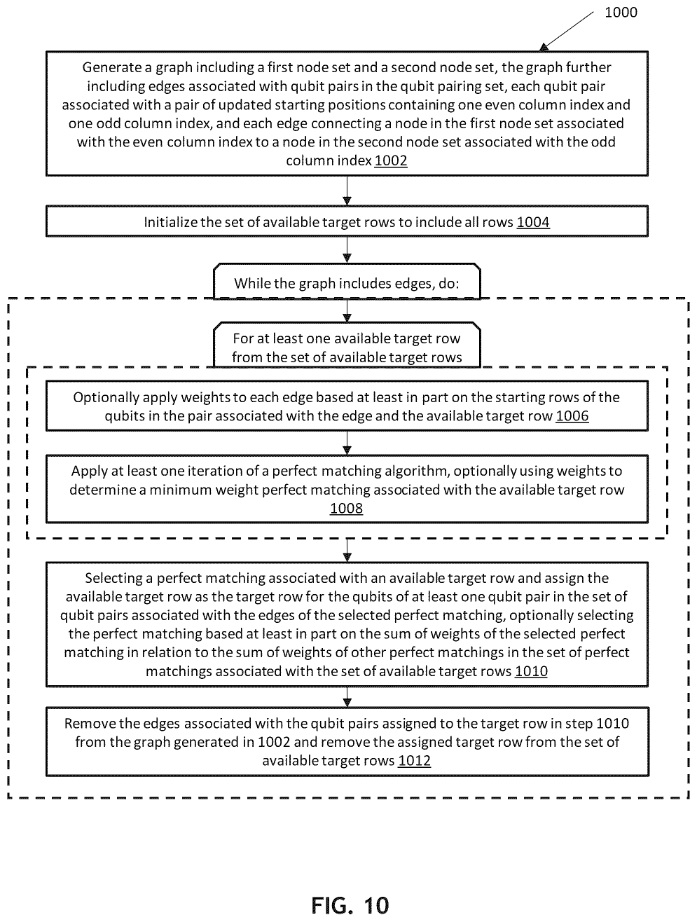

According to some examples, the process includes generating a set of target row assignments based at least in part on the set of starting positions at operation 806. In some embodiments, the set of target row assignments defines a row assigned for the target position of each qubit. In this regard, the set of target row assignments may define, for each row in a 2D quantum computing environment, the position indices of qubits to be repositioned to said row. The set of target row assignments in some embodiments includes the row of a target position determined for at least a portion of the qubit pairs based at least in part on the set of starting positions, for example where the target row assignment for the qubits is determined to enable efficient repositioning of the qubits based on a total number of parallel swap commands. In this regard, during generation of the target row assignments, each qubit of each qubit pair is assigned a particular target row determined to efficiently be reached based on the starting positions corresponding to such qubits and/or other qubits, and/or based on the qubit pairs for the particular time step. In some embodiments, the apparatus 200 generates the set of target row assignments for a qubit set by generating a graph and performing one or more iterations of a perfect matching algorithm, where each iteration of the perfect matching algorithm results in generation of particular target row assignments representing assigning of qubits to a particular row of the 2D quantum computing environment. Non-limiting examples of a sub-process for generating the set of target row assignments is depicted and described herein with respect to FIG. 10.

In some embodiments, the generation of the set of target row assignments results in a first set of swap-or-not operations. The first set of swap-or-not operations in some embodiments represents an ordered arrangement of whether to swap qubits at each position index of the 2D quantum computing environment across multiple time steps. Specifically, for example, the first set of swap-or-not operations may represent the swaps that reposition each qubit from its starting position represented in the set of starting positions to an intermediary position in the target row represented in the set of target row assignments. In some embodiments, the apparatus 200 tracks each swap required to reach the intermediary position during generation of the set of target row assignments and forms them into parallel swap-or-not commands. During each time step, such parallel swap-or-not operations may indicate a determination of whether each qubit is to be swapped or not swapped between rows of the 2D quantum computing environment for each qubit to reach its target row in accordance with the set of target row assignments.

It will be appreciated that the set of starting positions may embody the initial starting positions set, for example in a circumstance where the initial starting positions set is determined to satisfy the even-odd constraint. In other circumstances, the set of starting positions embodies an updated starting positions set, such as where the initial starting positions set was determined to not satisfy the even-odd constraint and a conversion is performed as described above.

According to some examples, the process includes generating a set of target column assignments corresponding to the set of target row assignments at operation 808. In some embodiments, the set of target column assignments is generated at least in part by efficiently sorting the qubits of each row defined based at least in part on the set of target row assignments from an intermediary position for each qubit. In some embodiments, the apparatus 200 generates the set of target column assignments on a row-by-row basis. In this regard, the apparatus 200 in some embodiments processes the intermediary positions of qubits assigned to each row utilizing an efficient 1D sorting algorithm based at least in part on each qubit pair. In some such embodiments, the efficient 1D sorting algorithm determines how to reposition the qubits assigned intermediary position of a given row defined based at least in part on the set of target row assignments to bring each qubit pair in the row into adjacency. A non-limiting example of a 1D sorting algorithm is depicted and described with respect to 1D compilation in U.S. application Ser. No. 17/319,511, titled “APPARATUSES, COMPUTER-IMPLEMENTED METHODS, AND COMPUTER PROGRAM PRODUCTS FOR INSTRUCTION COMPILATION FOR AT LEAST ONE TIME SLICE IN A ONE-DIMENSIONAL QUANTUM COMPUTING ENVIRONMENT” and filed May 13, 2021. It will be appreciated that no additional pre-processing of the qubit positions may be required before the generation of the set of target column assignments to satisfy the even-odd constraint, as the starting positions for the qubits already were determined to satisfy the even-odd constraint and the reach the intermediary positions defined based at least in part on the set of target row assignments does not effectuate any change that would cause violation of the even-odd constraint.

In some embodiments, the generation of the set of target column assignments results in a second set of swap-or-not operations. The second set of swap-or-not operations in some embodiments represents an ordered arrangement of whether to, across any number of time steps, swap qubits between columns of each position index of particular row of the 2D quantum computing environment. Specifically, for example, the second set of swap-or-not operations may represent the swaps that reposition each qubit of each row from its intermediary position in the particular target row to its particular target column within that row. The target column for a first qubit, as defined in the set of target column assignments, represents a particular column determined to be adjacent to a particular second column representing the target column for a second qubit of the same row, where the first qubit and second qubit form a qubit pair for the particular time step of the quantum program being processed. In some embodiments, the apparatus 200 tracks, based on the output of the 1D sorting algorithm, of each swap required to reach the target column of the target position during generation of the set of target column assignments. Such swaps are determined to require a particular number of time steps. During each time step, such swap-or-not operations may indicate a determination of whether each qubit is to be swapped or not swapped between columns of the 2D quantum computing environment for such a qubit to reach its target column in accordance with the set of target column assignments.

According to some examples, the process includes generating at least one movement instruction at optional operation 810. In some embodiments, the at least one movement instruction is based at least in part on a set of swap-or-not operations defined based at least in part on the set of target row assignments and the set of target column assignments. In some embodiments, the set of swap-or-not operations includes a first set of swap-or-not operations derived based on the generation of the set of target row assignments and includes a second set of swap-or-not operations derived based on the generation of the set of target column assignments. In some embodiments, the apparatus 200 generates movement instructions that are interpretable by one or more components of a quantum computer. The movement instructions are executable or otherwise interpretable by at least one component to facilitate at least one qubit manipulation that swaps qubits at particular position indices in the quantum computer. For example, in some embodiments, the apparatus 200 generates at least one movement instruction that actuates any one or more of the manipulation sources 60 and/or actuators 50 to facilitate such swaps of qubits. The manipulation movement instructions may be generated at particular timestamps and/or including particular data that triggers the execution of such manipulation instructions such that the swaps occur in a particular arrangement of ordered time steps defined for the set of swap-or-not operations.

According to some examples, the process includes causing execution of the at least one movement instruction at optional operation 812. In some embodiments, the apparatus 200 directly transmits the at least one movement instruction to at least one component of a quantum computer to facilitate execution of the at least one movement instruction via the at least one component. In some embodiments, the apparatus 200 transmits the at least one movement instruction to a controller of the quantum computer, such that the controller 30 forwards the movement instructions or further processes the at least one movement instruction to generate lower-level actuation commands that are transmitted to the at least one component of the quantum computer to execute particular qubit manipulations. In some embodiments, the apparatus 200 specifically actuates specific quantum components of the quantum computer, for example where the quantum components directly interact with or otherwise impact maintenance, storage, and/or use of the qubits in the quantum computer.

FIG. 9 illustrates a flowchart including example operations of a process for updating an initial starting positions set in accordance with at least one example embodiment of the present disclosure. Specifically, FIG. 9 depicts operations of an example process 900. In some embodiments, the process 900 embodies a sub-process of another computer-implemented process, such as the process 800. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one computing entity 10, quantum components of a quantum computer, and/or the like, to perform one or more of the operation(s) as depicted and described. For purposes of simplifying the description, the process 900 is described as performed by and from the perspective of the apparatus 200.

The process 900 begins at operation 902. In some embodiments, the process 900 begins after one or more operations depicted and/or described with respect to any of the other processes described herein. For example, in some embodiments as depicted, the process 900 begins before and/or at execution of optional operation 802. In this regard, some or all of the process 900 may replace or supplement one or more blocks depicted and/or described with respect to any of the other processes described herein. For example, in some embodiments as depicted, the process 900 supplants, supplements, and/or otherwise replaces an operation of the process 800, such as optional operation 804. Additionally or alternatively, as depicted, upon completion of the process 900, flow may return to one or more operations of another process. For example, as depicted, flow may return operation 806 as depicted and described.

According to some examples, the method includes determining, from an initial starting positions set, at least one qubit pair of the set of qubit pairs does not satisfy an even-odd constraint at operation 902. In some embodiments, the apparatus 200 processes each qubit pair to determine whether each qubit pair corresponds to a tuple of even-odd position indices. In a circumstance where the apparatus 200 determines that one of the qubit pairs is associated with a pair of even-even position indices and/or odd-odd position indices, the apparatus 200 determines that the initial starting positions set does not satisfy the even-odd constraint.

According to some examples, the method includes identifying at least one candidate swappable path based at least in part on the initial starting positions set at operation 904. In some embodiments, the apparatus 200 determines at least one non-compliant terminal in the qubit pairs set, for example a qubit pair including an even-even or odd-odd position indices. For example, in some embodiments, the apparatus 200 checks the column index of each qubit for each qubit pair to ensure that such column indices are associated with differing parities (e.g., one qubit with an odd column index and one qubit with an even column index). Additionally or alternatively, in some embodiments, the apparatus 200 determines candidate swappable paths including a single terminal qubit (e.g., a single qubit with an even column index or an odd column index) satisfying certain other conditions.

In some embodiments, the apparatus 200 identifies any first type of candidate swappable path including a path from an even-even column index qubit pair to an odd-odd column index qubit pair via any number of intermediary even-odd column index qubit pairs. Additionally or alternatively, in some embodiments, the apparatus 200 identifies any second type of candidate swappable path including a path from an even-even column index qubit pair to a single odd column index qubit (or a qubit pair including a single odd column index qubit and any free space or other qubit not relevant to a particular logical gate operation) via any number of intermediary odd-even column index qubit pairs. Additionally or alternatively, in some embodiments, the apparatus 200 defines any third type of candidate swappable path including a path from a single even column index qubit (or a qubit pair including a single even column index qubit and any free space or other qubit not relevant to a particular logical gate operation) to an odd-odd column index qubit pair via any number of intermediary odd-even column index qubit pairs. The apparatus 200 may process the current position indices of the qubits based on qubit pairs to determine any of such candidate swappable paths based on the current position indices (e.g., the initial starting positions set). In this regard, any of such candidate swappable paths may be swapped along the entirety of the identified path to convert the qubits along the swappable path to positions satisfying the even-odd constraint.

According to some examples, the method includes identifying at least one swappable path based at least in part on the at least one candidate swappable path at operation 906. For example, in some embodiments, the apparatus 200 generates a graph based on the candidate swappable paths identified at operation 904. In some embodiments, a source node is generated and connected via a zero-weight edge with each first non-compliant terminal of each candidate swappable path. The source node may be connected in some embodiments to non-compliant terminals that are even column indices or even-even column indices for qubit pairs. Additionally, a target node is generated and connected via a zero-weight edge with each second terminal of each candidate swappable path. In some embodiments, the target node is connected to non-compliant terminals that are odd column indices or odd-odd column indices for qubit pairs. An edge is created for each of the candidate swappable paths that connects the corresponding node of the first non-compliant terminal of that candidate swappable path with the corresponding node representing the second terminal of that candidate swappable path. In circumstances where a non-compliant terminal includes a qubit group having two qubits (e.g., an assigned even-even column index qubit pair for gating and/or an assigned odd-odd column index qubit pair for gating), such nodes may include up to two edges that are (i) outward for nodes connected to the source node, or (ii) incoming for nodes that are connected to the target node. For example, an even-even column index qubit pair (2, 6) connected to an odd-odd column index qubit pair may be associated with a first edge from a first column index based on the first qubit of the even-even column index qubit pair (e.g., a candidate swappable path beginning from the 2 column index) and/or a second edge from the second column index based on the second qubit of the even-even column index qubit pair (e.g., a path beginning from the 6 column index).

In some embodiments, the apparatus 200 assigns weight to each edge that represents a determined swap cost associated with performing a parallel swap step of swaps along the candidate swappable path represented by the edge. For example, in some embodiments, the apparatus 200 determines a swap cost for a particular candidate swappable path by performing the subsequent steps of the efficient compiling algorithm (as described herein) for an updated starting positions set that would be reached by performing swaps along the candidate swappable path, and assigning the weight of the edge based on the number of parallel swap steps required to complete the efficient compiling algorithm. In some embodiments, the weights are compared to the number of parallel swap steps required to complete the efficient compiling algorithm after performing the swaps along the candidate swappable path as compared to a current number of parallel swap steps to complete the efficient compiling algorithm without such swaps along the candidate swappable path. In this regard, the apparatus 200 may perform this process for each edge to assign a weight to each before further processing.

Once weights are assigned, in some embodiments the apparatus 200 processes the graph utilizing one or more efficient disjoint path algorithm. For example, in some embodiments, the apparatus 200 processes the graph utilizing a modified Suurballe's algorithm. The modified Suurballe's algorithm is depicted and described further in U.S. patent application Ser. No. 17/319,511, filed May 13, 2021, and titled “APPARATUSES, COMPUTER-IMPLEMENTED METHODS, AND COMPUTER PROGRAM PRODUCTS FOR INSTRUCTION COMPILATION FOR AT LEAST ONE TIME SLLICE IN A ONE-DIMENSIONAL QUANTUM COMPUTING ENVIRONMENT,” the contents of which are incorporated by reference herein in their entireties. The modified Suurballe's algorithm determines cost-effective paths for converting the initial starting positions set to an updated set of starting positions for further processing.

According to some examples, the method includes swapping at least one qubit of each qubit pair of at least a subset of the at least one qubit pair based at least in part on the at least one swappable path to generate an updated set of starting positions at operation 908. In some embodiments, for example, the apparatus 200 updates the initial starting positions set by performing the swaps of qubit indices corresponding to the qubits along the swappable paths identified at operation 906. In this regard, the swaps corresponding to a single parallel swap step comprising a number of swap-or-not operations that swap certain adjacent qubits along the identified swappable paths and yields the updated starting positions set for such qubits that now satisfies the even-odd constraint and can be further processed, for example by the remaining full stages of the efficient compiling algorithm as depicted and described herein, for example via at least the remaining operations as depicted and described with respect to FIG. 8 herein.

FIG. 10 illustrates a flowchart including example operations of a process for generating target row assignments in accordance with at least one example embodiment of the present disclosure. Specifically, FIG. 10 depicts operations of an example process 1000. In some embodiments, the process 1000 embodies a sub-process of another process as depicted and described herein, for example process 800 as depicted and described herein. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as the apparatus 200 alone or in communication with one or more other component(s), device(s), system(s), and/or the like. In this regard, in some such embodiments, the apparatus 200 is specially configured by computer-coded instructions (e.g., computer program instructions) stored thereon, for example in the memory 204 and/or another component depicted and/or described herein and/or otherwise accessible to the apparatus 200, for performing the operations as depicted and described. In some embodiments, the apparatus 200 is in communication with one or more external apparatus(es), system(s), device(s), and/or the like, to perform one or more of the operations as depicted and described. For example, the apparatus 200 in some embodiments is in communication with at least one computing entity 10, quantum components of a quantum computer, and/or the like, to perform one or more of the operation(s) as depicted and described. For purposes of simplifying the description, the process 1000 is described as performed by and from the perspective of the apparatus 200.

The process 1000 begins at operation 1002. In some embodiments, the process 1000 begins after one or more operations depicted and/or described with respect to any of the other processes described herein. For example, in some embodiments as depicted, the process 1000 begins before and/or at execution of operation 804. In this regard, some or all of the process 1000 may replace or supplement one or more blocks depicted and/or described with respect to any of the other processes described herein. For example, in some embodiments as depicted, the process 1000 supplants, supplements, and/or otherwise replaces an operation of the process 800, such as operation 806. Additionally or alternatively, upon completion of the process 1000, flow may return to one or more operations of another process. For example, upon completion of the process 1000, the flow may continue to operation 808, in an example embodiment.

According to some examples, the method includes generating a graph at operation 1002. In some embodiments, the apparatus 200 generates the graph including a first node set and a second node set. In some embodiments, the first node set includes at least one node corresponding to each even column index for the number of columns in the 2D quantum computing environment. In some embodiments, the second node set includes at least one node corresponding to each odd column index for the number of columns in the 2D quantum computing environment. In this regard, the first node of the first node set and the first node of the second node set represents a first even column index and a first odd column index of the 2D quantum computing environment, the second node of the first node set and the second node of the second node set represent a second even column index and a second odd column index of the 2D quantum computing environment, and so on.

The graph further includes an edge for each particular qubit pair of the set of qubit pairs for a particular time step of a quantum program. In some embodiments, the edge for a particular qubit pair extends from a first node of the first node set to a second node of the second node set, where the first node corresponds to the even column index of the qubit pair and the second node corresponds to the odd column index of the qubit pair. The position indices of the qubit pair in some embodiments are represented by particular position indices in the set of starting positions corresponding to particular qubits associated with the qubit pair.

According to some examples, the method includes initializing a set of available target rows at operation 1004. In various embodiments, the set of available target rows is initialized to include all rows or a selected subset of rows of the 2D qubit containment apparatus 150. For example, a set of available target rows is initialized and/or defined such that the set of available target rows includes include all rows or a selected subset of rows of the 2D qubit containment apparatus 150.

While the graph still includes edges, the process 1000 loops and/or repeats through operations 1006, 1008, 1010, and 1012. For at least one available target row of the set of available target rows, the operations 1006 and 1008 are performed.

At optional operation 1006, respective edge weights are applied to each edge of the graph based at least in part on the starting rows of the qubits in the qubit pair associated with the edge and the available target row. For example, in some embodiments, the respective edge weights of each edge associated with a qubit pair may be determined based at least in part on the two distances from the two starting rows of the qubits in the qubit pair to the available target row. In some embodiments, the edge weight assigned to an edge is determined based at least in part on the maximum of the two distances from the two starting rows of the qubits in the qubit pair associated with the corresponding edge. In some embodiments, the edge weight assigned to an edge is determined based at least in part on the average of the two distances from the two starting rows of the qubits in the qubit pair associated with the edge. In some embodiments, the edge weight assigned to an edge is determined based at least in part on a histogram or distribution of distances from the two starting rows of the qubits in the qubit pair associated with the edge. In some embodiments, the edge weight assigned to an edge is determined based at least in part on an estimate of the number of steps to sort using even-odd transposition, odd-even transposition sort, or other sort method from the two starting rows of the qubits associated with the edge to the available target row including any previously assigned rows. In some embodiments, the edge weight assigned to an edge is determined based at least in part on a maximum, average, distribution, or histogram of number of steps to sort the associated qubits. In some embodiments, the edge weight assigned to an edge is determined based at least in part on a heuristic method for approximating cost to move qubits associated with the edge from their starting rows to the available target row. In some embodiments, the edge weights are orderable and summable for use in minimum weight perfect matching algorithms, for example.

At operation 1008, at least one iteration of a perfect matching algorithm is performed. In an example embodiment that includes operation 1006, the perfect matching algorithm makes use of the edge weights applied to the edges of the graph to determine a minimum weight perfect matching associated with the available target row.

In some embodiments, the perfect matching algorithm determines a perfect matching that covers each node with exactly one adjacent edge. In this regard, each iteration of the perfect matching algorithm may be utilized to identify a set of qubit pairs that are to be assigned to a next row in the 2D quantum computing environment, where the set of edges connect nodes corresponding to various qubit pairs at different columns, such that each column in a target row assignment corresponds only to one qubit for each row. In some embodiments, an iteration of the perfect matching algorithm is performed as depicted and described with respect to FIG. 6.

In some embodiments, optional operation 1006 and operation 1008 are performed for a set of available target rows resulting in a set of perfect matchings, one such perfect matching associated with one such available target row for each of the available target rows. In an example embodiment that includes operation 1006 and the perfect matchings so generated in 1008 are minimum weight perfect matchings, each minimum weight perfect matching associated with an available target row from the set of available target rows include a cost of the perfect matching given by the sum of the edge weights of the edges selected in the perfect matching. In some embodiments, a perfect matching associated with an available target row from the set of available target rows becomes a candidate target row assignment for the qubit pairs associated with the edges of the perfect matching, and the set of perfect matchings then becomes a set of different candidate target row assignments for the different sets of qubit pairs associated with the perfect matchings associated with each of the different available target rows. In an example embodiment where the perfect matchings are minimum weight perfect matchings each having a cost given by the sum of the edge weights of the edges in the perfect matching, associated candidate target row assignments are comparable and orderable based on this cost.

According to some examples, the method includes generating a target row assignment for one or more qubit pairs in the set of qubit pairs at operation 1010. In some embodiments, generating the target row assignment includes selecting a perfect matching associated with an available target row and assigning the available target row as the target row for the one or more qubit pairs associated with the edges in the perfect matching. For example, a perfect matching associated with an available target row is selected and the available target row of the selected perfect matching is assigned as the target row for the qubits of the one or more qubit pairs associated with edges of the selected perfect matching.

In various embodiments, the perfect matching is selected based at least in part on the sum of edge weights of the selected perfect matching in relation to the sum of edge weights of other perfect matchings in the set of prefect matchings associated with the set of available target rows. For example, respective sums of edge weights of the perfect matchings may be determined, and a perfect matching may be selected based on a comparison of the respective sums of edge weights of the perfect matchings. For example, in various embodiments, a perfect matching associated with a maximum or a minimum of the respective sums of edge weights of the perfect matchings is selected.

At operation 1012, the edges associated with the qubit pairs assigned to the target row in operation 1010 are removed from the graph generated at operation 1002 and the assigned target row is removed from the set of available target rows. Operations 1006-1012 are repeated until all of the edges have been removed from the graph.

### Conclusion

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
identifying a set of starting positions corresponding to a set of qubit pairs for a set of qubits, the set of starting positions representing a two-dimensional environment comprising a number of rows and a number of columns;
generating a set of target row assignments based at least in part on the set of starting positions, the set of target row assignments comprising a target row assignment for each qubit pair in the set of qubit pairs, wherein the set of target row assignments is generated corresponding to a first set of swap-or-not operations;
generating a set of target column assignments comprising a target column assignment for each qubit pair in the set of qubit pairs, the set of target column assignments generated by applying a one-dimensional sorting algorithm to each row of the set of target row assignments, wherein the set of target column assignments is generated corresponding to a second set of swap-or-not operations; and
generating at least one movement instruction based at least in part on the first set of swap-or-not operations and the second set of swap-or-not operations.

2. The computer-implemented method of claim 1, further comprising:
determining the set of starting positions satisfies an even-odd constraint for each qubit pair.

3. The computer-implemented method of claim 1, wherein the set of starting positions comprises a set of updated starting positions, the computer-implemented method further comprising:
determining, from an initial starting positions set, at least one qubit pair of the set of qubit pairs does not satisfy an even-odd constraint; and
swapping at least one qubit of each qubit pair of at least a subset of the at least one qubit pair to generate the updated set of starting positions, wherein the updated set of starting positions satisfies the even-odd constraint for each qubit pair of the set of qubit pairs.

4. The computer-implemented method of claim 3, wherein each swap to generate the updated set of starting positions is performed in a single time step.

5. The computer-implemented method of claim 3, further comprising:
identifying at least one swappable path, wherein each swappable path of the at least one swappable path connects first non-compliant terminal with a second terminal,
wherein swapping the at least one qubit of each qubit pair of at least the subset of the at least one qubit pair represents each swap along the at least one swappable path.

6. The computer-implemented method of claim 5, wherein each swappable path comprises:
the first non-compliant terminal embodying an even-even qubit pair and the second terminal embodying an odd-odd qubit pair, the first non-compliant terminal and the second terminal connected by zero or more even-odd intermediary qubit pairs;
the first non-compliant terminal embodying an even-even qubit pair and the second terminal embodying an odd-only qubit, the first non-compliant terminal and the second terminal index connected by zero or more odd-even intermediary qubit pairs; or
the first non-compliant terminal embodying an odd-odd qubit pair and the second terminal qubit embodying an even-only qubit, the first non-compliant terminal and the second terminal index connected by zero or more odd-even intermediary qubit pairs.

7. The computer-implemented method of claim 5, wherein identifying the at least one swappable path comprises:
identifying a plurality of candidate swappable paths, each candidate swappable path connecting a first candidate non-compliant terminal with a second candidate non-compliant terminal or terminal index;
generating a graph, wherein the graph comprises a first node set comprising a node for each first candidate non-compliant terminal and wherein the graph comprises a second node set comprises a node for each second candidate non-compliant terminal or terminal index, and wherein the graph comprises an edge connecting each first node of the first node set with a second node in the second node set, wherein the first node is associated with at least a first qubit adjacent to a second qubit of the swappable path connected to the second node; and
identifying the at least one swappable path by applying an efficient disjoint path algorithm to the graph.

8. The computer-implemented method of claim 7, further comprising:
assigning a weight to each edge, wherein the weight for each particular edge is determined based at least in part on a swap cost determined based at least in part on the initial starting positions and a second set of starting positions after swapping the candidate swappable path corresponding to the particular edge.

9. The computer-implemented method of claim 5, further comprising:
identifying an additional candidate swappable path representing a closed cycle path, and
including the additional candidate swappable path in the at least one swappable path.

10. The computer-implemented method of claim 5, further comprising:
identifying an additional candidate swappable path comprising a first terminal representing a terminal even index and a second terminal representing a second terminal representing a terminal odd index;
generating an alternative starting positions set representing swapping along the additional candidate swappable path;
determining the alternative starting positions set is associated with a swap savings compared to the initial starting positions set; and
including the additional candidate swappable path in the at least one swappable path.

11. The computer-implemented method of claim 1, wherein generating the set of target row assignments comprises:
generating a graph comprising a first node set and a second node set, wherein the first node set comprises at least one node corresponding to each even column index for the number of columns and wherein the second node set comprises at least one node corresponding to each odd column index for the number of columns,
wherein the graph further comprises an edge for each particular qubit pair from a first node of the first node set to a second node of the second node set, the first node corresponding to a first column of a first starting position of a first qubit of the particular qubit pair and the second node corresponding to a second column a second starting position of a second qubit of the particular qubit pair; and
assigning starting positions to each target row to generate a target row assignment corresponding to the target row by at least:
applying at least one iteration of a perfect matching algorithm for each row.

12. The computer-implemented method of claim 11, wherein the perfect matching algorithm comprises a minimum weight perfect matching algorithm that performs based on edge weights determined at least in part on the starting rows of the qubit pairs associated with the edges and a candidate target row.

13. The computer-implemented method of claim 12, wherein the first target row is selected from a set of available target rows based at least in part on the sum of weights of the minimum weight perfect matching associated with the target row in relation to the sum of weights of minimum weight perfect matchings associated with one or more available target rows.

14. The computer-implemented method of claim 1, further comprising:
transmitting the at least one movement instruction to an external controller that, in response to receiving the at least one movement instruction, controls a quantum computer based at least in part on the at least one movement instruction.

15. The computer-implemented method of claim 1, further comprising:
activating a quantum computer to perform the first set of swap-or-not operations and the second set of swap-or-not operations represented by the at least one movement instruction.

16. A computing entity comprising at least one processor and a memory storing computer-executable code, the memory and the computer executable code configured to, when executed by the at least one processor, cause the computing entity to perform at least:
identifying a set of starting positions corresponding to a set of qubit pairs for a set of qubits, the set of starting positions representing a two-dimensional environment comprising a number of rows and a number of columns;
generating a set of target row assignments based at least in part on the set of starting positions, the set of target row assignments comprising a target row assignment for each qubit pair in the set of qubit pairs, wherein the set of target row assignments is generated corresponding to a first set of swap-or-not operations;
generating a set of target column assignments comprising a target column assignment for each qubit pair in the set of qubit pairs, the set of target column assignments generated by applying a one-dimensional sorting algorithm to each row of the set of target row assignments, wherein the set of target column assignments is generated corresponding to a second set of swap-or-not operations; and
generating at least one movement instruction based at least in part on the first set of swap-or-not operations and the second set of swap-or-not operations.

17. The computing entity of claim 16, wherein the memory and the computer executable code configured to, when executed by the at least one processor, further cause the computing entity to perform determining the set of starting positions satisfies an even-odd constraint for each qubit pair.

18. The computing entity of claim 16, wherein the set of starting positions comprises a set of updated starting positions, wherein the memory and the computer executable code configured to, when executed by the at least one processor, further cause the computing entity to perform:
determining, from an initial starting positions set, at least one qubit pair of the set of qubit pairs does not satisfy an even-odd constraint; and
swapping at least one qubit of each qubit pair of at least a subset of the at least one qubit pair to generate the updated set of starting positions, wherein the updated set of starting positions satisfies the even-odd constraint for each qubit pair of the set of qubit pairs.

19. The computing entity of claim 16, wherein generating the set of target row assignments comprises:
generating a graph comprising a first node set and a second node set, wherein the first node set comprises at least one node corresponding to each even column index for the number of columns and wherein the second node set comprises at least one node corresponding to each odd column index for the number of columns,
wherein the graph further comprises an edge for each particular qubit pair from a first node of the first node set to a second node of the second node set, the first node corresponding to a first column of a first starting position of a first qubit of the particular qubit pair and the second node corresponding to a second column a second starting position of a second qubit of the particular qubit pair; and
assigning starting positions to each target row to generate a target row assignment corresponding to the target row by at least:
applying at least one iteration of a perfect matching algorithm for each row.

20. A computer program product comprising at least one non-transitory storage medium storing executable instructions, the executable instructions configured to, when executed by one or more processors of a computing entity, cause the computing entity to perform:
identifying a set of starting positions corresponding to a set of qubit pairs for a set of qubits, the set of starting positions representing a two-dimensional environment comprising a number of rows and a number of columns;
generating a set of target row assignments based at least in part on the set of starting positions, the set of target row assignments comprising a target row assignment for each qubit pair in the set of qubit pairs, wherein the set of target row assignments is generated corresponding to a first set of swap-or-not operations;
generating a set of target column assignments comprising a target column assignment for each qubit pair in the set of qubit pairs, the set of target column assignments generated by applying a one-dimensional sorting algorithm to each row of the set of target row assignments, wherein the set of target column assignments is generated corresponding to a second set of swap-or-not operations; and
generating at least one movement instruction based at least in part on the first set of swap-or-not operations and the second set of swap-or-not operations.
